(19) United States
(12) Patent Application Publication
(10) Pub. No.: US 2026/0295710 A1
(43) Pub. Date: Oct. 1, 2026

(54) MANUFACTURING METHOD OF FLASH BUTT WELDED RAIL

(71) Applicant: NIPPON STEEL CORPORATION, Chiyoda-ku, Tokyo (JP)

(72) Inventors: Masaharu UEDA, Tokyo (JP); Suo SARUWATARI, Tokyo (JP); Toshiyuki MANABE, Tokyo (JP)

(73) Assignee: NIPPON STEEL CORPORATION, Chiyoda-ku, Tokyo (JP)

(21) Appl. No.: 19/490,986

(22) PCT Filed: Mar. 8, 2024
(86) PCT No.: PCT/JP2024/009130

§ 371 Date: Dec. 8, 2025

(30) Foreign Application Priority Data
Jul. 20, 2023 (JP) 2023-118424

(51) Int. Cl. B23K 11/04; B23K 101/26; B23K 103/04; C22C 38/00; C22C 38/02; C22C 38/04; C22C 38/06; C22C 38/20; C22C 38/22; C22C 38/24; C22C 38/26; C22C 38/28; C22C 38/30; C22C 38/32; C22C 38/50; E01B 11/46; E01B 11/50

(52) U.S. Cl. CPC B23K 11/046; C22C 38/001; C22C 38/002; C22C 38/005; C22C 38/02; C22C 38/04; C22C 38/06; C22C 38/20; C22C 38/22; C22C 38/24; C22C 38/26; C22C 38/28; C22C 38/30; C22C 38/32; C22C 38/50; E01B 11/46; E01B 11/50; B23K 2101/26; B23K 2103/04

(57) ABSTRACT

A manufacturing method of a flash butt welded rail having a plurality of rail portions; and a weld joint portion joining the plurality of rail portions, the method including: flash butt welding rails; and forced cooling the weld joint portion immediately after the flash butt welding is completed, wherein when the forced cooling is performed from an austenite temperature range, in a welding center of the weld joint portion, a cooling stop temperature TC of an outline surface of a head top corner is 560° C. or higher and 850° C. or lower; and a cooling stop temperature TA of an outline surface of a head jaw is 650° C. or higher and 950° C. or lower.

### TECHNICAL FIELD

The present invention relates to a manufacturing method of a flash butt welded rail.

Priority is claimed on Japanese Patent Application No. 2023-118424, filed Jul. 20, 2023, the content of which is incorporated herein by reference.

### BACKGROUND ART

Flash butt welding is widely used as a rail welding method. As the features of flash butt welding, it is known that automation is possible, quality stability is high, and welding time is short.

Flash butt welding is a technique in which rail end surfaces are melted by heating, and then the melted surfaces are brought into pressure contact with each other to join the rails to each other. During flash butt welding, the rails are heated from room temperature to near their melting point at most and then cooled. Therefore, the metallographic structure and hardness of the rail are changed by flash butt welding. The portion where metallurgical properties, mechanical properties, and the like have been changed by heat such as welding and cutting is called a heat affected zone (HAZ).

In the HAZ, there are austenitization and pearlite transformation of the metallographic structure accompanied by heating to the Al point or more during welding; and partial austenitization of the metallographic structure and decomposition of the pearlite structure accompanied by heating to near the Al point. There has been a problem that the portion austenitized during flash butt welding is subjected to forced cooling by air cooling immediately after the welding in order to secure the hardness of the welded portion, thereby generating a martensite structure harmful to toughness.

There has been a problem in that a martensite structure easily becomes a starting point of fracture, and when a martensite structure is generated, rail breakage easily occurs. Characteristically, the martensite structure is easily generated in the head of the weld joint portion of the rails, whose cooling rate is relatively high. In addition, characteristically, the head is a site requiring wear resistance, and therefore needs to be cooled at higher speed than other sites in order to suppress softening, but easily generates a martensite structure by subcooling.

For cooling the weld joint portion obtained by subjecting rails to flash butt welding or the like, the following technique has been proposed in order to improve the fatigue strength of the weld joint by controlling residual stress.

Patent Document 1 describes a cooling method for cooling a rail weld, the method including cooling the column, the foot, and the head in a temperature range in which transformation from the austenite to the pearlite is completed. The technique of Patent Document 1 aims to reduce residual stress in the rail weld and improve the fatigue strength of the rail weld joint portion.

For a weld joint portion of a flash butt welded rail, the following technique has been proposed in order to control the welding conditions and the conditions of cooling the head and improve the life of the weld joint.

Patent Document 2 describes a welding method and a cooling method including: performing flash butt welding in an upset amount of 20 mm or more; starting cooling the rail head within 70 seconds after the welding is completed; and stopping cooling 25 to 60 seconds after the cooling is started.

Further, there has been a problem that a rail having a high carbon component promotes the formation of a pro-eutectoid cementite structure having low toughness at the weld joint portion of the welded rail when the carbon amount is increased, thereby increasing the possibility of rail breakage or the like. Therefore, in order to improve the toughness of the weld joint portion, the following technique has been proposed.

Patent Document 3 describes a heat treatment method for a weld joint portion in which, in rail welding, either one or both of a rail head and a rail bottom heated to a range of 800 to 900° C. in a two-phase state in which an austenite phase and a cementite phase are mixed are accelerated and cooled from a temperature range of 750° C. or higher at a cooling rate of 1 to 10° C./sec, accelerated cooling is stopped when the temperature of either one or both of the head and the bottom of the steel rail reaches 680 to 550° C., and thereafter, one or both of them are radiationally cooled or slowly cooled so as not to exceed 680° C., formation of pro-eutectoid cementite structure is suppressed, and the toughness of a rail weld joint portion is improved.

### CITATION LIST

### Patent Documents

Patent Document 1: PCT International Publication No. WO 2010/116680
Patent Document 2: Japanese Unexamined Patent Application, First Publication No. 2010-100937
Patent Document 3: Japanese Unexamined Patent Application, First Publication No. 2004-043862

### SUMMARY OF INVENTION

### Technical Problem

However, the technique of Patent Document 1 does not aim to control the formation of a martensite structure in the jaw of the head, which promotes rail breakage. Therefore, the technique has no effect of improving rail breakage resistance. The technique of Patent Document 1 does not control the cooling rate of the jaw of the head, where a martensite structure harmful to toughness is generated. In the technique, the cooling rate is controlled at a position 20 mm away from the welding center in the rail axial direction. The position is outside the general HAZ portion (within 20 mm), where martensite is formed. Therefore, the temperature control of the technique is not to control the formation of a martensite structure in the weld joint portion.

The technique of Patent Document 2 aims to reduce defects in the rail weld, and further, secure the hardness of the weld joint portion and improve the life of the rail weld joint portion. However, the technique of Patent Document 2 does not aim to control the formation of a martensite structure in the jaw of the head, which promotes rail breakage. Therefore, the technique has no effect of improving rail breakage resistance.

The technique of Patent Document 3 aims to suppress the formation of a pro-eutectoid cementite structure that reduces the toughness of the rail weld joint portion and improve the breakage resistance of the rail weld joint portion. However, the technique of Patent Document 3 does not aim to control the formation of a martensite structure, which promotes rail breakage, and has no effect of drastically improving rail breakage resistance. In addition, the technique of Patent Document 3 mainly controls the cooling rate of the head and the bottom of the rail, and does not control the generation of the microstructure of the jaw of the head, where a martensite structure harmful to toughness is generated.

The present invention has been made in view of the above problems, and an object of the present invention is to improve the breakage resistance of the weld joint portion of a flash butt welded rail. Preferably, an object of the present invention is to provide a manufacturing method that satisfies the extremely severe requirements of breakage resistance for the weld joint portion of the flash butt welded rail for freight trains, which are under a severe raceway environment.

### Solution to Problem

The gist of the present invention is as follows.

(1) An embodiment of the present invention is a manufacturing method of a flash butt welded rail having a plurality of rail portions; and a weld joint portion joining the plurality of rail portions, the method including: flash butt welding rails, the rails including, as a chemical composition, in terms of unit mass %, C: 0.70 to 1.20%, Si: 0.05 to 2.00%, Mn: 0.05 to 2.00%, P≤0.0300%, S≤0.0300%, Cr: 0 to 2.00%, Mo: 0 to 0.50%, Co: 0 to 1.00%, B: 0 to 0.0050%, Cu: 0 to 1.00%, Ni: 0 to 1.00%, V: 0 to 0.200%, Nb: 0 to 0.0500%, Ti: 0 to 0.0500%, Mg: 0 to 0.0200%, Ca: 0 to 0.0200%, REM: 0 to 0.0500%, N: 0 to 0.0200%, Zr: 0 to 0.0200%, Al: 0 to 1.0000%, and a balance including Fe and impurities; and cooling the weld joint portion immediately after the flash butt welding is completed, wherein when the forced cooling is performed from an austenite temperature range, in a welding center of the weld joint portion, a cooling stop temperature TC of an outline surface of a head top corner is 560° C. or higher and 850° C. or lower; and a cooling stop temperature TA of an outline surface of a head jaw is 650° C. or higher and 950° C. or lower.

(2) Preferably, in the manufacturing method of a flash butt welded rail according to (1), the cooling stop temperature TC of the outline surface of the head top corner and the cooling stop temperature TA of the outline surface of the head jaw satisfy formulae 1 and 2 below:

$$TA + TC \geq 1340 \qquad formula 1$$

$$0 \leq TA - TC \leq 140. \qquad formula 2$$

(3) Preferably, in the manufacturing method of a flash butt welded rail according to (1) or (2), the rails include, as the chemical composition, in terms of unit mass %, one or more group of: Group a: Cr: 0.05% or more and 2.00% or less, and Mo: 0.01% or more and 0.50% or less; Group b: Co: 0.01% or more and 1.00% or less; Group c: B: 0.0001% or more and 0.0050% or less; Group d: one or two of Cu: 0.01% or more and 1.00% or less and Ni: 0.01% or more and 1.00% or less; Group e: one or more of V: 0.005% or more and 0.200% or less, Nb: 0.0010% or more and 0.0500% or less, and Ti: 0.0010% or more and 0.0500% or less; Group f: one or more of Mg: 0.0005% or more and 0.0200% or less, Ca: 0.0005% or more and 0.0200% or less, and REM: 0.0005% or more and 0.0500% or less; Group g: N: 0.0025% or more and 0.0200% or less; Group h: Zr: 0.0001% or more and 0.0200% or less; and Group i: Al: 0.0010% or more and 1.0000% or less.

(4) Preferably, in the manufacturing method of a flash butt welded rail according to any one of (1) to (3), the forced cooling is air cooling.

### Advantageous Effects of Invention

According to the above embodiments of the present invention, it is possible for a flash butt welded rail to improve the breakage resistance of the weld joint portion and significantly improve the service life.

### BRIEF DESCRIPTION OF DRAWINGS

FIG. 1A side view of a welded rail.

FIG. 2A cross-sectional view perpendicular to the longitudinal direction of a welded rail.

FIG. 3A perspective view schematically illustrating the position of the weld joint portion of a welded rail in the longitudinal cross section.

FIG. 4A schematic diagram of the cross-sectional hardness distribution of the weld joint portion of a welded rail in the longitudinal cross section 5 mm inside the outline surface of the head jaw.

FIG. 5A schematic view of a martensite structure evaluation region of the weld joint portion of a welded rail in the longitudinal cross section.

FIG. 6A schematic view of a falling weight test.

FIG. 7A relationship between the number of martensite structures formed in the head jaw and rail breakage (falling weight height: 5.0 m; falling weight energy: 49.0 kN·m).

FIG. 8A relationship between the number of martensite structures formed in the head jaw and rail breakage (falling weight height: 7.0 m; falling weight energy: 73.5 kN·m).

FIG. 9A relationship between the cooling stop temperature (TC) of the outline surface of the head top corner and the number of martensite structures formed in the head jaw.

FIG. 10A relationship between the cooling stop temperature (TA) of the outline surface of the head jaw and the number of martensite structures formed in the head jaw.

FIG. 11A relationship between the sum of the cooling stop temperatures (TA+TC) of the head top corner and the head jaw and the number of martensite structures formed in the head jaw.

FIG. 12A relationship between the difference of the cooling stop temperatures (TA-TC) of the head top corner and the head jaw and the number of martensite structures formed in the head jaw.

FIG. 13A relationship between the sum of the cooling stop temperatures (TA+TC) of the head top corner and the head jaw and the number of martensite structures formed in the head jaw (TA−TC=145 to 250).

FIG. 14A relationship between the difference of the cooling stop temperatures (TA−TC) of the head top corner and the head jaw and the number of martensite structures formed in the head jaw (TA+TC=1250 to 1330).

FIG. 15 An example of the Fe—Fe₃C equilibrium state diagram for determining the austenite region temperature (cited from “Iron and Steel Materials”, The Japan Institute of Metals and Materials).

FIG. 16A A photograph of the appearance of the weld joint portion of a welded rail after trimming (bead cutting).

FIG. 16B A photograph of the appearance of the weld joint portion of a welded rail after trimming.

FIG. 17A schematic view of an example of a cooling device suitable for carrying out a manufacturing method of a welded rail.

### DESCRIPTION OF EMBODIMENTS

In order to solve the problem, the inventors investigated the cause of the breakage of the weld joint portion and studied to prevent the breakage caused from brittle fracture and generated from the head jaw of the weld joint portion. As a result, it has been confirmed that the breakage often starts from a brittle crack generated from the jaw of a rail head, and that a martensite structure has been generated at the starting portion of the brittle crack. Therefore, the present inventors analyzed the relationship between the martensite structure and the cooling conditions of the weld joint portion and found that there is a correlation between the cooling conditions and the generation of the martensite structure. Then, the present inventors confirmed that the cooling conditions of the weld joint portion can be controlled to suppress the generation of the martensite structure. The present inventors have found a manufacturing method of a rail to stably improve the use performance of the weld joint portion of a welded rail used under a severe use environment.

An embodiment of the present invention is a manufacturing method of a flash butt welded rail 1 having a plurality of rail portions 11; and a weld joint portion 12 joining the plurality of rail portions 11, the method including: flash butt welding rails, the rails including, as a chemical composition, in terms of unit mass %, C: 0.70 to 1.20%, Si: 0.05 to 2.00%, Mn: 0.05 to 2.00%, P≤0.0300%, S≤0.0300%, and a balance including Fe and impurities; and cooling the weld joint portion 12 immediately after the flash butt welding is completed, wherein when the forced cooling is performed from an austenite temperature range, in a welding center A of the weld joint portion 12, a cooling stop temperature (TC) of an outline surface of a head top corner 1214 is 560° C. or higher; and a cooling stop temperature (TA) of an outline surface of a head jaw 1212 is 650° C. or higher. The manufacturing method of a flash butt welded rail according to the embodiment will be described in detail below.

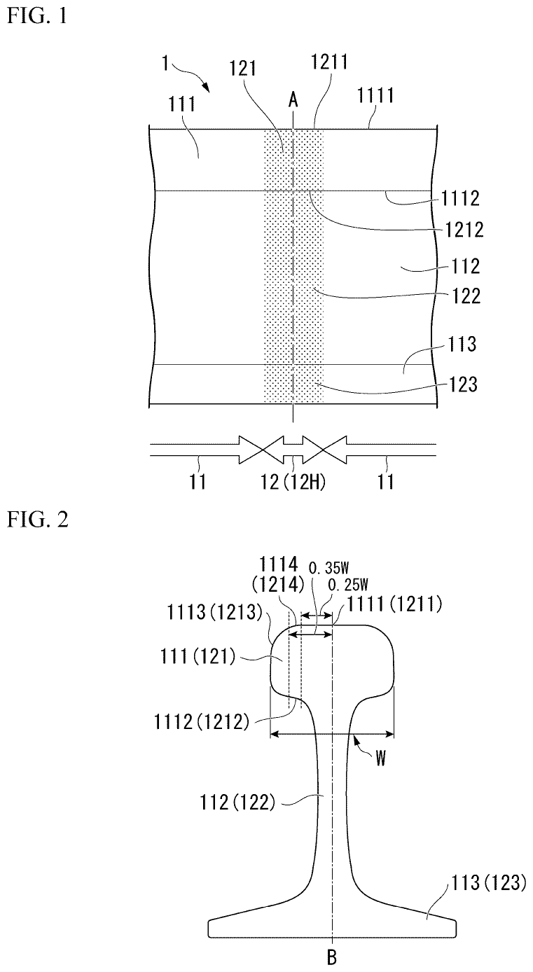

As shown in FIG. 1, the flash butt welded rail (hereinafter, simply referred to as “welded rail 1”) includes a plurality of rail portions 11 and a weld joint portion 12 that joins the rail portions 11. The present inventors have extensively conducted studies on a method for improving the breakage resistance of the weld joint portion 12. The present inventors have found that the breakage resistance of the weld joint portion 12 is improved when the cooling stop temperature of the outline surface of the head top corner 1214 in the welding center A of the weld joint portion 12 and the cooling stop temperature of the outline surface of the head jaw 1212 of the weld joint portion 12 are controlled to a certain temperature or more.

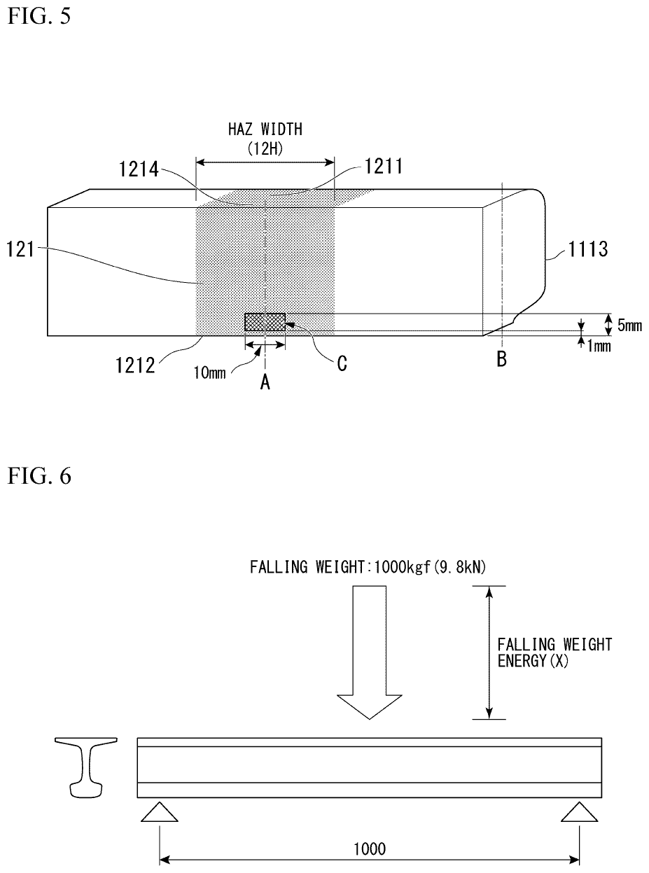

Then, the present inventors have optimized the heat treatment conditions after welding is completed, thereby reducing the amount of a martensite structure generated in the martensite structure evaluation region C in the head jaw of the head 121 of the weld joint portion 12, as illustrated in FIG. 5. As a result, the present inventors have been able to improve the breakage resistance of the weld joint portion 12 and greatly improve the service life thereof.

The manufacturing method of a flash butt welded rail according to an embodiment of the present invention obtained based on the above findings will be described in detail. First, the terms used in the embodiment are described.

A flash butt welded rail 1 is a rail obtained by joining rails by flash butt welding. Hereinafter, the flash butt welded rail 1 is simply referred to as “welded rail 1”.

As shown in FIGS. 1 and 2, the welded rail 1 includes a plurality of rail portions 11 each having a rail head 111, a rail column 112, and a rail bottom 113, and a weld joint portion 12 that joins these rail portions 11. In FIG. 1, the reference sign “A” indicates the welding center to be described later. Hereinafter, the simple description “rail” means a rail before welding, and the description “rail portion” means the base material portion of the welded rail 1.

The rail head 111 of the rail portion 11 refers to the portion above the constricted portion at the center in the vertical direction of the rail portion 11 in the cross section perpendicular to the longitudinal direction of the rail portion 11 shown in FIG. 2. In addition, the rail column 112 refers to the constricted portion at the center in the vertical direction of the rail portion 11 in the cross section of the rail portion 11 shown in FIG. 2. Furthermore, the rail bottom 113 refers to the portion below the constricted portion at the center in the vertical direction of the rail portion 11 in the cross section of the rail portion 11 shown in FIG. 2.

In addition, in the rail head 111, the upper outline surface is referred to as rail head top surface or outline surface of rail head top 1111, the upper corner outline surface is referred to as outline surface of rail head top corner 1114, and the upper side outline surface is referred to as outline surface of rail head side 1113. The constricted portion below the rail head 111 is referred to as outline surface of rail head jaw 1112.

As illustrated in FIG. 2, the outline surface of the rail head top corner 1114 is the outline surface positioned 0.25 W to 0.35 W away from the center (B) of the width (W) of the rail head 111 toward the outline surface of the rail head side 1113. As illustrated in FIG. 2, the outline surface of the rail head jaw 1112 is the outline surface positioned 0.25 W to 0.35 W away from the center (B) of the width (W) of the rail head toward the outline surface of the rail head side 1113. As a matter of course, the vertical direction of the welded rail 1 means the vertical direction when the welded rail 1 is used as a raceway.

FIG. 2 describes a broken line separated 0.25 W away from the center of the rail head 111 in the width direction and extending along the vertical direction of the rail portion 11; and a broken line separated 0.35 W away from the center of the rail head 111 in the width direction and extending along the vertical direction of the rail portion 11. Within the rail head top surface, the region positioned between these broken lines is the outline surface of the rail head top corner 1114. Within the surface of the jaw of the rail head, the region positioned between these broken lines is the outline surface of the rail head jaw 1112.

The weld joint portion 12 is the “weld joint” defined in JIS Z 3001-1:2018 and means a connected portion in which members are united by welding. In the embodiment, the member is a rail that is a material of the rail portion 11.

In the welded rail 1, the shape of the weld joint portion 12 is substantially the same as that of the rail portion 11. Therefore, the weld joint portion 12 also has a head 121, a column 122, and a bottom 123 similarly to the rail portion 11. The head 121 of the weld joint portion 12 has an outline surface of a head top 1211, an outline surface of a head top corner 1214, an outline surface of a head side 1213, and an outline surface of a head jaw 1212. Hereinafter, the name of the head of the rail portion 11 is referred to as “rail head 111”, and the name of the head of the weld joint portion 12 is simply referred to as “head 121”. Regarding other sites, the term “rail” is attached when the site is included in the rail portion 11, and the term “rail” is not attached when the site is included in the weld joint portion 12.

The heat-affected zone (HAZ) 12H means the base metal portion that has not been melted and has been changed in metallurgical properties, mechanical properties and the like due to the heat of welding, cutting, and the like, as defined in JIS Z 3001-1:2018. In the embodiment, the base metal is the rail portion 11.

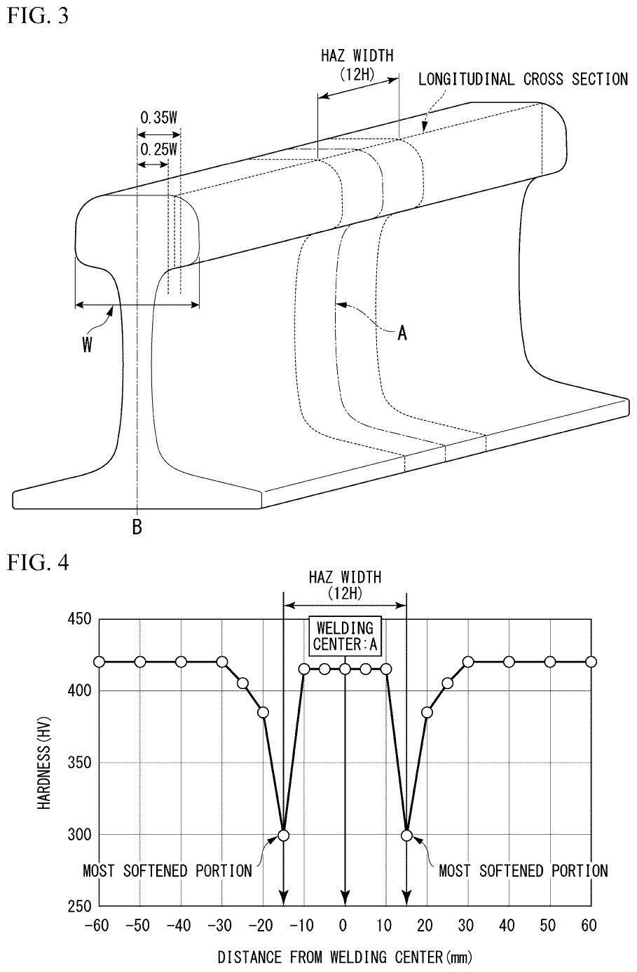

As illustrated in FIG. 3, the welded rail 1 according to the embodiment has the width of the heat-affected zone 12H along the longitudinal direction of the welded rail 1, that is, the HAZ width. In the welded rail 1 according to the embodiment, the HAZ width is defined based on the hardness distribution of the weld joint portion 12 that is measured at a cut surface passing through a cross section that is parallel to the longitudinal direction of the welded rail 1 and positioned 0.25 W to 0.35 W away from the center (B) of the width of the head of the welded rail 1 toward the outline surface of the head side 1213. In the embodiment, the cut surface passing through a cross section that is parallel to the longitudinal direction of the welded rail 1 and positioned 0.25 W to 0.35 W away from the center (B) of the width of the head of the welded rail 1 toward the outline surface of the head side 1213 is referred to as “longitudinal cross section”. FIG. 3 describes a broken line separated 0.25 W away from the center of the rail head 111 in the width direction and extending along the vertical direction of the rail portion 11; and a broken line separated 0.35 W away from the center of the rail head 111 in the width direction and extending along the vertical direction of the rail portion 11. The longitudinal cross section is a cut surface along the vertical direction of the rail and formed at an arbitrary position between these broken lines. Hereinafter, the overview of the hardness distribution of the weld joint portion 12 is described, and then the definition of the HAZ width is described.

FIG. 4 schematically shows the hardness distribution in the longitudinal cross section of the weld joint portion 12. The graph was obtained by continuously measuring Vickers hardness in the longitudinal cross section of the weld joint portion 12 along the outline surface of the head jaw 1212 at the position having a depth of 5 mm from the outline surface of the head jaw 1212 of the weld joint portion 12 toward the outline surface of the head top corner 1214. Note that the welding center A described in the graph means a straight line along the vertical direction of the welded rail, the straight line passing through the center of the heat-affected zone 12H in the longitudinal cross section of the weld joint portion 12. Typically, the welding center A generally coincides with the joint of the rails.

The weld joint portion 12 includes a region formed therein where the austenite is formed as a whole by heating to the Al point or higher due to welding heat and then transformed into the pearlite by cooling after the welding is completed. In addition, on both sides of the region, there are regions where the austenite is partially formed by heating near the Al point due to welding heat, and then, the pearlite structure is decomposed by cooling after the welding is completed. In these regions, the hardness is significantly reduced. Therefore, usually, in the hardness distribution graph of the welded rail 1 obtained by flash butt welding, two valleys of Vickers hardness exist as shown in FIG. 4. The places where these valleys of Vickers hardness occur are defined as the most softened portion of the welded rail 1 according to the embodiment. The interval between the two most softened portions is defined as the HAZ width. The welding center A substantially coincides with the center of the HAZ width.

As illustrated in FIG. 5, the martensite structure evaluation region C means a region (C) that ranges±5 mm (width 10 mm) in the longitudinal direction of the welded rail 1 from the welding center A in the longitudinal cross section and has a depth of 1 to 5 mm from the outline surface of the head jaw 1212 toward the outline surface of the head top corner 1214. The technical significance of the martensite structure evaluation region C is described later.

The martensite structure evaluation region (C) is a region included in the longitudinal cross section at a position 0.25 W to 0.35 W away from the center (B) of the width of the head of the welded rail toward the outline surface of the head side 1213. There are two longitudinal cross sections on the left and right of the center of the width of the head. Either of the two cross sections may be set. The longitudinal cross section is a cross section passing through the outline surface of the head jaw 1212. Thus, the lower end of the cross section coincides with the outline surface of the head jaw 1212. When the martensite structure evaluation region C is specified in accordance with the above definition, the lower end of the cross section may be regarded as the outline surface of the head jaw 1212.

The forced cooling of the weld joint portion 12 means that a refrigerant such as air, water, and mist is sprayed to the weld joint portion 12. In the embodiment, the temperature decrease caused by leaving the weld joint portion 12 after welding in the atmosphere is referred to as radiational cooling of the weld joint portion 12 and is regarded as a concept different from the forced cooling of the weld joint portion 12.

The cooling stop temperature of the outline surface of the head top corner 1214 in the welding center A means the temperature of the outline surface of the head top corner 1214 that is measured at the time when the forced cooling is stopped, that is, at the time when spraying a refrigerant is stopped. Similarly, the cooling stop temperature of the outline surface of the head jaw 1212 in the welding center A means the temperature of the outline surface of the head jaw 1212 in the welding center A that is measured at the time when spraying a refrigerant is stopped.

Next, the technical idea of the present invention will be described. The present inventors have investigated damage occurring in the weld joint portion 12 of the welded rail 1. The present inventors investigated a damaged rail generated in an actual raceway and confirmed that the damage was often made in the form of breakage starting from a brittle crack generated from the head of the welded rail.

First, the present inventors identified the starting point of the breakage of the welded rail and confirmed that the breakage was generated from the heat-affected zone (HAZ) in many cases.

Next, the present inventors identified the site where the breakage was generated and confirmed that the breakage was generated from the region C illustrated in FIG. 5, and a martensite structure was formed in the region C, in many cases.

Therefore, first, the present inventors investigated the relationship between the generation status of the martensite structure in the site and the breakage of the rail weld joint portion. Using a hyper-eutectoid steel rail (0.80 to 1.20% of C), a flash butt welding test was performed, and a falling weight test was performed for the rail as illustrated in FIG. 6, thereby evaluating the relationship between the generation amount of the martensite structure and the presence or absence of the rail breakage. The generation amount of the martensite structure was controlled mainly by controlling the cooling stop temperatures of the outline surface of the head jaw and the outline surface of the head top corner in the region of +5 mm (width 10 mm) from the welding center (A) in the weld joint portion where the martensite structure was generated.

The rail, the flash butt welding conditions, the cooling conditions of the weld joint portion 12 after welding, the characteristics of the weld joint portion 12, the method for evaluating the martensite structure, and the conditions of the falling weight test were as follows.

### Rail Serving as Welding Base Metal

Components: including 0.70 to 1.20% of C, Si, and Mn, and a balance including iron and impurities
Rail shape: 136 lbs (weight: 67 kg/m)
Hardness: 420 HV (head top surface)

### Flash Butt Welding Conditions (Preheating Flash Method)

Initial flash time: 15 sec
Number of times of preheating: 10 times
Late flash time: 25 sec
Average late flash speed: 1.0 mm/see
Late flash speed immediately before upset (for 3 sec): 2.0 mm/see
Upset load: 65 KN
   Cooling Conditions of Weld Joint Portion 12 after Welding
Site: Welding center (A)
Cooling start time: 15 sec after welding is completed
Cooling stop temperature (TA) of outline surface of jaw portion on head 1212: 500 to 800° C.
Cooling stop temperature (TC) of outline surface of corner portion on head top 1214: 550 to 900° C.
Subsequent cooling (outline surface of jaw portion on head, outline surface of corner portion on head top): radiational cooling (to 50° C.)

In the embodiment, the description “subjecting the weld joint portion to forced cooling immediately after the flash butt welding is completed” means that forced cooling is started in 5 sec or more and 30 sec or less after the flash butt welding is completed. The time when flash butt welding is completed means the time when trimming is completed. In the trimming, the burr formed in the weld joint portion in upsetting of the flash butt welding is removed. The forced cooling started under the above conditions is regarded as the forced cooling started immediately after the flash butt welding is completed.

### Characteristics of Weld Joint Portion 12

HAZ width: 32 mm
Hardness of welding center A: 390 to 440 HV
Hardness of most softened portion: 280 HV

### Evaluation of Martensite Structure

Evaluation site (see FIG. 5) means a region that ranges±5 mm (width 10 mm) in the longitudinal direction of the welded rail from the welding center (A) in the longitudinal cross section of the weld joint portion and has a depth of 1 to 5 mm from the outline surface of the head jaw 1212 toward the outline surface of the head top corner (martensite structure evaluation region: C).

The reason for the selection of the evaluation site is because the starting point of rail breakage occurs there.

### Method for Revealing Martensite Structure:

After the martensite structure evaluation region (C) is polished, Nital etching is performed, followed by observation with an optical microscope.
Polishing conditions: buffing with 1 μm diamond paste
Martensite etching conditions
Etching solution: alcohol+5% nitric acid (Nital)
Etching time: 5 to 10 seconds
Investigation method for microstructure
Apparatus: optical microscope
Magnification: 400 times
Evaluation method for microstructure

The martensite structure that can be confirmed at a magnification of 400 times of the optical microscope was evaluated.

The target martensite structure had a long diameter of 25 to 100 μm, and when the martensite structure was generated, the number thereof was investigated.

### Falling Weight Test Conditions (See FIG. 6)

Attitude: The welded rail is supported at two points with the head on the lower side and the bottom on the upper side, and a falling weight is dropped to the bottom of the rail.
Span length (interval between two support points): 1000 mm
Weight of falling weight: 1000 kgf (9.8 kN)
Falling weight height (X): 5.0 and 7.5 m
Falling weight energy: 49.0 and 73.5 kN·m

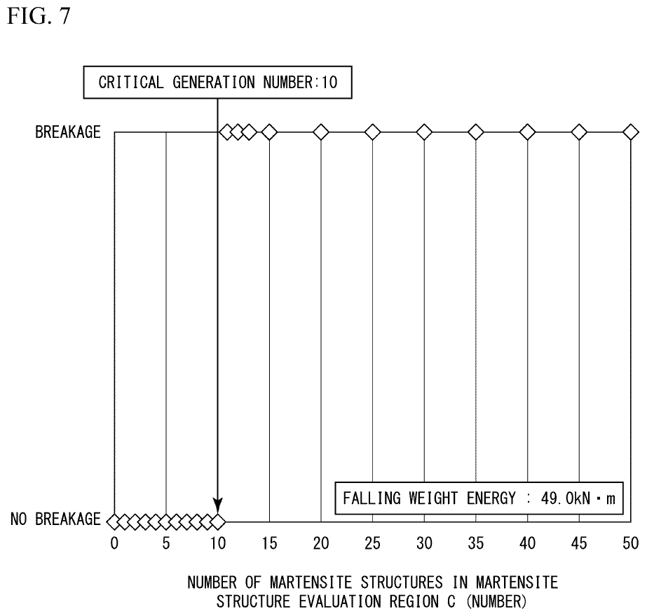

As a result, when the falling weight height is 5.0 m (falling weight energy is 49.0 kN·m), as shown in FIG. 7 and the number of martensite structures generated in the martensite structure evaluation region C near the outline surface of the head jaw 1212 was 10 or less, breakage in the rail weld joint portion was prevented.

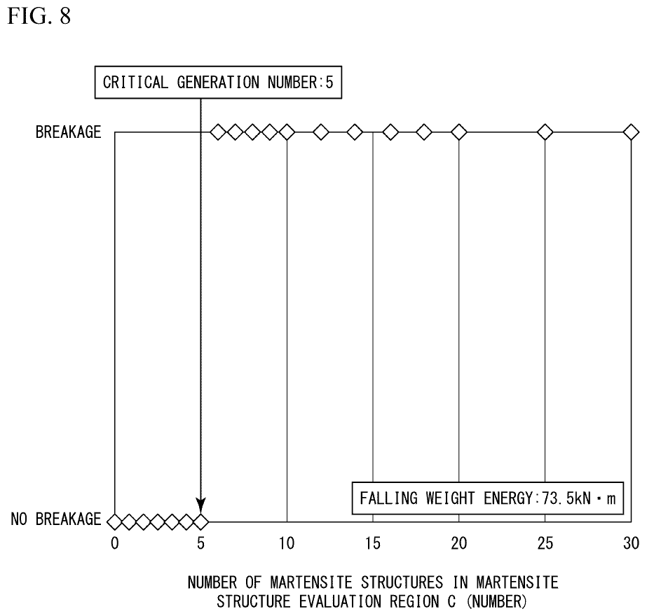

Further, when the falling weight height is 7.5 m (falling weight energy is 73.5 kN·m), as shown in FIG. 8, and the number of martensite structures generated in the martensite structure evaluation region C near the outline surface of the head jaw 1212 was 5 or less, breakage was prevented in the rail weld joint portion. In this case, it is considered that breakage of the welded rail can be effectively suppressed even under a more severe use environment.

Furthermore, the present inventors investigated the relationship between the heat treatment conditions after flash butt welding and the generation of the martensite structure in the martensite structure evaluation region C in order to control the amount of the martensite structure generated in the martensite structure evaluation region C.

Using a hyper-eutectoid steel rail (0.70 to 1.20% of C), a flash butt welding test was performed, and a falling weight test was performed for the rail as illustrated in FIG. 6, thereby evaluating the relationship between the generation amount of the martensite structure in the martensite structure evaluation region C and the presence or absence of the rail breakage. The generation amount of the martensite structure was controlled mainly by controlling the cooling stop temperatures of the outline surface of the head jaw 1212 and the outline surface of the head top corner 1214 in the region of ±5 mm (width 10 mm) from the welding center (A) in the weld joint portion 12 where the martensite structure was generated. The rail, the flash butt welding conditions, the characteristics of the weld joint portion 12, and the method for evaluating the martensite structure are as described above.

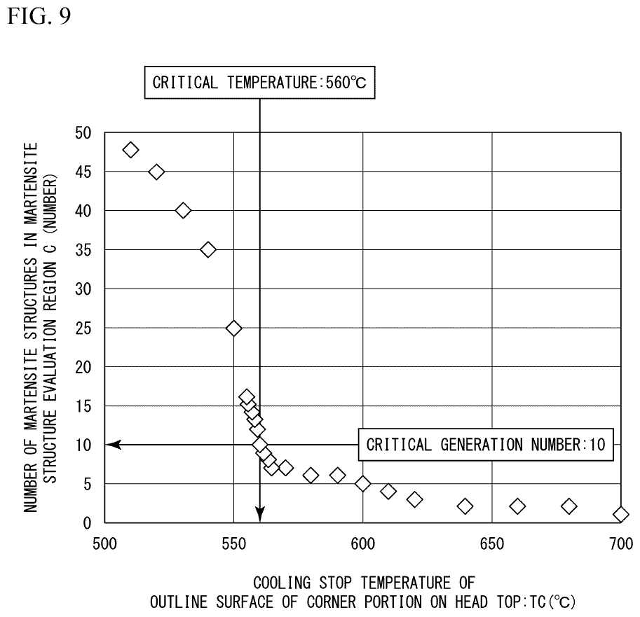

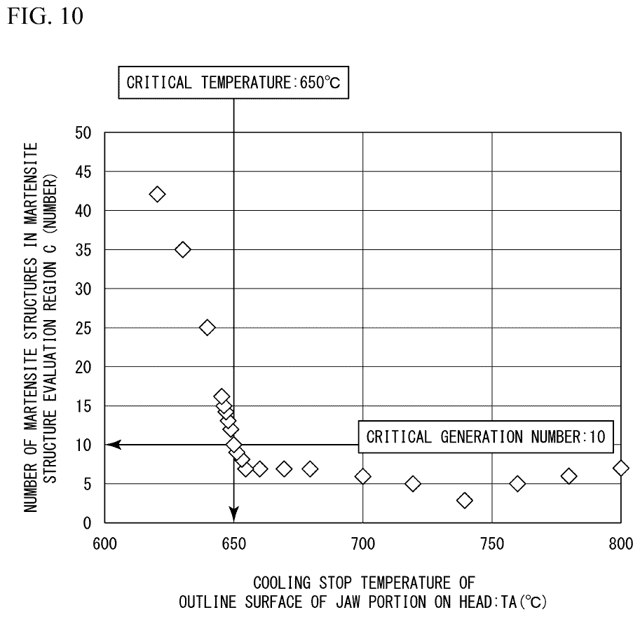

Cooling Conditions of Weld Joint Portion 12 after Welding
Site: Welding center (A)
Cooling start time: 15 sec after welding is completed
Case of controlling the stop temperature of the outline surface of the head top corner 1214 (FIG. 9)
Cooling stop temperature (TA) of outline surface of jaw portion on head 1212: 740° C.
Cooling stop temperature (TC) of outline surface of corner portion on head top 1214: 510 to 700° C.
Cooling stop temperature (TA) of outline surface of jaw portion on head≥Cooling stop temperature (TC) of outline surface of corner portion on head top
Case of controlling the cooling stop temperature of the outline surface of the head jaw 1212 (FIG. 10)
Cooling stop temperature of outline surface of jaw portion on head 1212: 620 to 800° C.
Cooling stop temperature of outline surface of corner portion on head top 1214: 620° C.
Cooling stop temperature (TA) of outline surface of jaw portion on head≥Cooling stop temperature (TC) of outline surface of corner portion on head top
Subsequent cooling (outline surface of jaw portion on head, outline surface of corner portion on head top): radiational cooling (to 50° C.)

### Falling Weight Test Conditions (See FIG. 6)

Attitude: The welded rail is supported at two points with the head on the lower side and the bottom on the upper side, and a falling weight is dropped to the bottom of the rail.
Span length (interval between two support points): 1000 mm
Force of falling weight: 1000 kgf (9.8 kN)
Falling weight height (X): 5.0 m
Falling weight energy: 49.0 kN·m

As shown in FIG. 9, it was confirmed that when the cooling stop temperature of the outline surface of the head top corner 1214 is 560° C. or higher, the number of martensite structures generated in the martensite structure evaluation region C is 10 or less.

Further, as shown in FIG. 10, it was confirmed that when the cooling stop temperature of the outline surface of the head jaw 1212 is 650° C. or higher, the number of martensite structures generated in the martensite structure evaluation region C is 10 or less.

Therefore, it was confirmed that when the cooling stop temperature of the outline surface of the head jaw 1212 and the cooling stop temperature of the outline surface of the head top corner 1214 are controlled, the amount of martensite structures generated in the martensite structure evaluation region C is controlled to 10 or less, and the rail weld joint portion can be prevented from breakage.

Furthermore, the present inventors conceived of a method of further reducing the generation amount of the martensite structure further improving the breakage resistance of the weld joint portion 12.

The cooling stop temperature of the outline surface of the head jaw 1212 and the cooling stop temperature of the outline surface of the head top corner 1214 are preferably controlled with each other in order to reduce the generation amount of the martensite structure. Then, an experiment was conducted focusing on the sum of the cooling stop temperature (TA) of the outline surface of the head jaw 1212 and the cooling stop temperature (TC) of the outline surface of the head top corner 1214; and the difference of the cooling stop temperature (TA) of the outline surface of the head jaw 1212 and the cooling stop temperature (TC) of the outline surface of the head top corner 1214.

Using a hyper-eutectoid steel rail (0.70 to 1.20% of C), a flash butt welding test was performed. Then, the relationship between the cooling stop temperature conditions and the generation amount of the martensite structure was evaluated while the cooling stop temperature (TA) of the outline surface of the head jaw 1212 of the weld joint portion 12 and the cooling stop temperature (TC) of the outline surface of the head top corner 1214 were changed.

The rail, the flash butt welding conditions, the characteristics of the weld joint portion 12, and the method for evaluating the martensite structure are as described above.

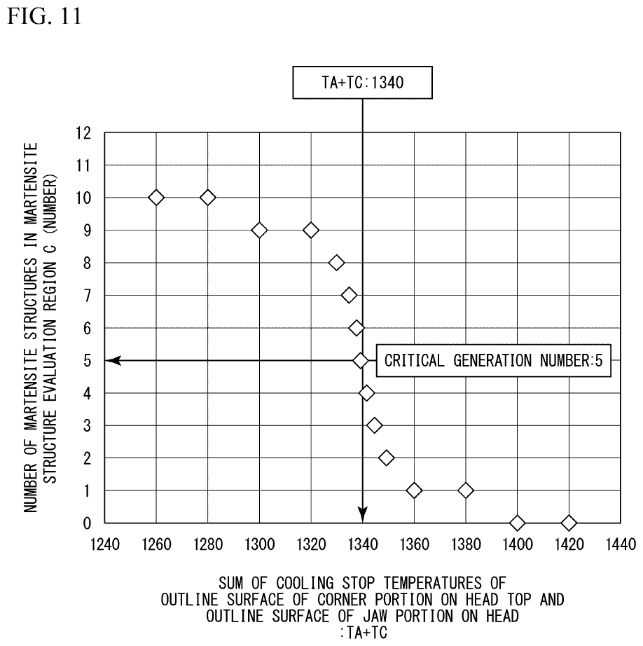

Cooling Conditions of Weld Joint Portion after Welding
Case of controlling the sum of the cooling stop temperature (TA) of the outline surface of the head jaw 1212 in the welding center (A) and the cooling stop temperature (TC) of the outline surface of the head top corner 1214 (FIG. 11)

$$TA - TC = 50 ( fixed )$$

TA: 650 to 800° C., TC: 600 to 750° C.

$$TA \geq TC$$

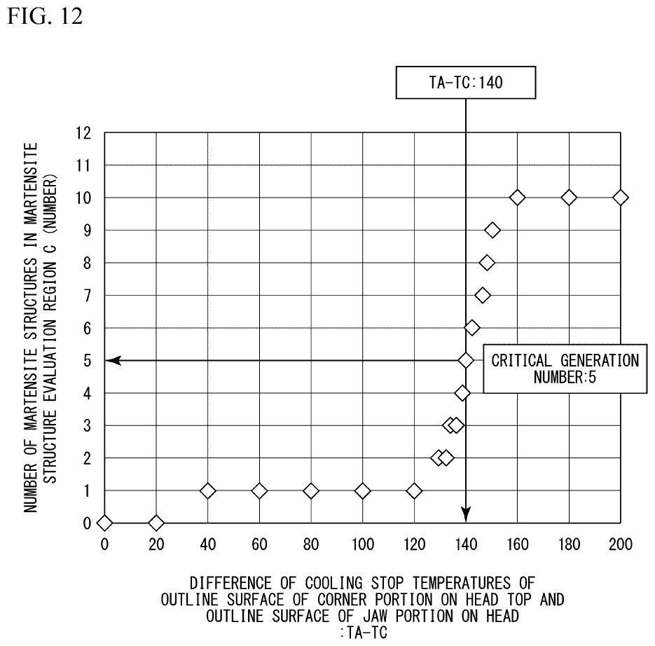

Case of controlling the difference of the cooling stop temperature (TA) of the outline surface of the head jaw 1212 in the welding center (A) and the cooling stop temperature (TC) of the outline surface of the head top corner 1214 (FIG. 12)

$$TA + TC = 1400 ( fixed )$$

TA: 700 to 800° C., TC: 600 to 700° C.

$$TA \geq TC$$

Subsequent cooling (outline surface of jaw portion on head, outline surface of corner portion on head top): radiational cooling (to 50° C.)

As a result, as shown in FIG. 11, it was confirmed that when the sum of the cooling stop temperature (TA) of the outline surface of the head jaw 1212 and the cooling stop temperature (TC) of the outline surface of the head top corner 1214 is 1340° C. or higher, the number of martensite structures generated in the martensite structure evaluation region C is 5 or less.

Further, as shown in FIG. 12, it was confirmed that when the difference of the cooling stop temperature (TA) of the outline surface of the head jaw 1212 and the cooling stop temperature (TC) of the outline surface of the head top corner 1214 is 140° C. or lower, the number of martensite structures generated in the martensite structure evaluation region C is 5 or less.

Therefore, it has been confirmed that when the sum and difference of the cooling stop temperature (TA) of the outline surface of the head jaw 1212 and the cooling stop temperature (TC) of the outline surface of the head top corner 1214 are controlled, the generation amount of martensite structures can be controlled to 5 or less, and the rail weld joint portion can be further improved in breakage resistance.

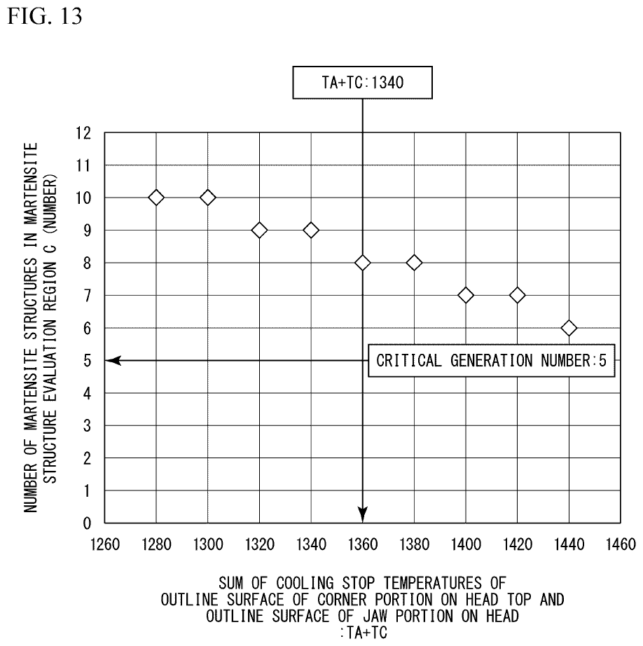

When the sum of the cooling stop temperature (TA) of the outline surface of the head jaw 1212 and the cooling stop temperature (TC) of the outline surface of the head top corner 1214 is controlled and the difference of the cooling stop temperature (TA) of the outline surface of the head jaw 1212 and the cooling stop temperature (TC) of the outline surface of the head top corner 1214 is in a range of 160 to 240° C., as shown in FIG. 13, the sum of the cooling stop temperature (TA) of the outline surface of the head jaw 1212 and the cooling stop temperature (TC) of the outline surface of the head top corner 1214 becomes 1340° C. or higher, but the number of martensite structures generated in the martensite structure evaluation region C does not become 5 or less.

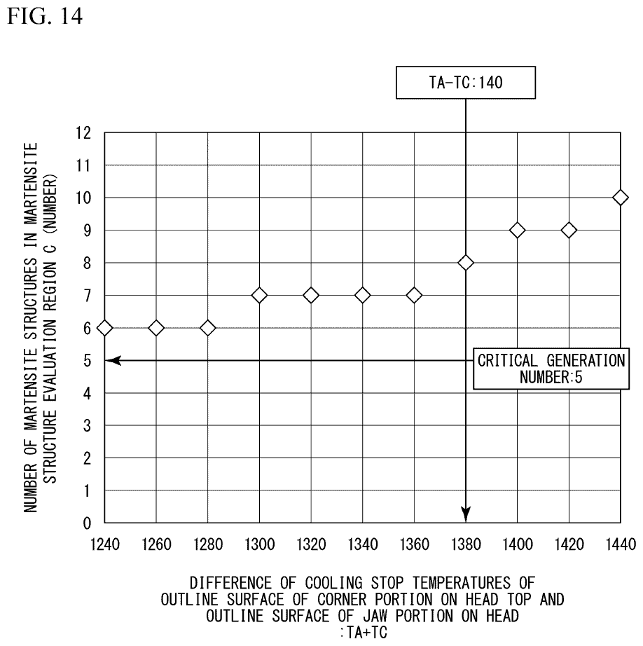

Similarly, when the difference of the cooling stop temperature (TA) of the outline surface of the head jaw 1212 and the cooling stop temperature (TC) of the outline surface of the head top corner 1214 is controlled and the sum of the cooling stop temperature (TA) of the outline surface of the head jaw 1212 and the cooling stop temperature (TC) of the outline surface of the head top corner 1214 is in a range of 1250 to 1330° C., as shown in FIG. 14, the difference of the cooling stop temperature (TA) of the outline surface of the head jaw 1212 and the cooling stop temperature (TC) of the outline surface of the head top corner 1214 becomes 140° C. or lower, but the number of martensite structures generated in the martensite structure evaluation region C does not become 5 or less.

In order that the number of generated martensite structures is controlled to 5 or less, it is preferable to control both the sum and difference of the cooling stop temperature (TA) of the outline surface of the head jaw 1212 and the cooling stop temperature (TC) of the outline surface of the head top corner 1214.

From these results, when the flash butt welded rail 1 is controlled in the cooling stop temperature (TC) of the outline surface of the head top corner 1214 and the cooling stop temperature (TA) of the outline surface of the head jaw 1212 in the welding center A of the weld joint portion 12 and is suppressed in the amount of the martensite structure generated in the martensite structure evaluation region C in the longitudinal cross section, it is possible to further suppress breakage caused by a brittle crack generated from the head 121 of the welded rail 1 and greatly improve the service life of the welded rail 1.

The manufacturing method of the flash butt welded rail 1 obtained based on the above findings will be described in detail below. Hereinafter, the unit “mass %” of the content of the alloy component is simply described as “%”.

### (1) Reasons for Limitation of Chemical Composition of Rail

The manufacturing method of the welded rail 1 according to the embodiment includes flash butt welding rails as the material of the welded rail 1. Hereinafter, the reason for limitation of the chemical composition of the rail before welding will be described in detail. However, the chemical composition of the rail before welding is the same as the chemical composition of the rail portion 11 of the welded rail 1. Therefore, the upper and lower limits of the alloy elements described for the chemical composition of the rail also apply to the chemical composition of the rail portion 11.

### (C: 0.70 to 1.20%)

C is an element effective for promoting pearlite transformation and ensuring the wear resistance of the weld joint portion 12. When the amount of C is less than 0.70%, the minimum strength and wear resistance required for the weld joint portion 12 cannot be maintained. On the other hand, when the amount of C exceeds 1.20%, a large amount of pro-eutectoid cementite structure is formed in the weld joint portion 12, and the breakage resistance of the weld joint portion 12 is deteriorated. Therefore, the C content is limited to 0.70 to 1.20%. The C content is preferably 0.72% or more, 0.75% or more, or 0.80% or more. The C content is preferably 1.18% or less, 1.15% or less, or 1.10% or less. In order to stabilize the formation of the pearlite structure, the C content is desirably 0.80 to 1.10%.

### (Si: 0.05 to 2.00%)

Si is an element that is solid-solved in a ferrite phase having a pearlite structure, increases the hardness of the weld joint portion 12, and improves the wear resistance. However, when the amount of Si is less than 0.05%, these effects cannot be sufficiently expected. On the other hand, when the amount of Si exceeds 2.00%, the toughness of the pearlite structure decreases, and the breakage resistance of the weld joint portion 12 decreases. Therefore, the Si content is limited to 0.05 to 2.00%. The Si content is preferably 0.10% or more, 0.20% or more, 0.30% or more, or 0.40% or more. The Si content is preferably 1.80% or less, 1.60% or less, or 1.50% or less. In order to stabilize the formation of the pearlite structure and improve the breakage resistance of the weld joint portion 12, the Si content is desirably 0.40 to 2.00%.

### (Mn: 0.05 to 2.00%)

Mn is an element that enhances hardenability of the welded rail 1, stabilizes pearlite transformation, and at the same time, refines the lamellar interval of the pearlite structure, secures the hardness of the weld joint portion 12, and further improves wear resistance. However, when the amount of Mn is less than 0.05%, the effect is small, and the wear resistance of the weld joint portion 12 is deteriorated. On the other hand, when the amount of Mn exceeds 2.00%, an excessive amount of Mn promotes the Mn enrichment in the segregation portion, promotes the formation of a martensite structure in the weld joint portion 12, and reduces the breakage resistance. Therefore, the Mn content is limited to 0.05 to 2.00%. The Mn content is preferably 0.10% or more, 0.20% or more, 0.30% or more, or 0.40% or more. The Mn content is preferably 1.80% or less, 1.60% or less, or 1.50% or less. In order to stabilize the formation of the pearlite structure and improve the wear resistance and breakage resistance of the weld joint portion 12, the Mn content is desirably 0.40 to 1.50%.

$$( P \leq 0.03 \% )$$

P is an impurity element contained in steel. When the amount of P exceeds 0.0300%, the breakage resistance of the weld joint portion 12 is deteriorated due to embrittlement of the pearlite structure. Therefore, the P content is limited to 0.0300% or less. The lower limit of the P content does not need to be limited, and may be, for example, 0%, but the lower limit of the P content may be about 0.0020% in consideration of the dephosphorization ability in refining. The P content is preferably 0.0025% or more, 0.0030% or more, or 0.0050% or more. The P content is preferably 0.0250% or less, 0.0200% or less, or 0.0150% or less. In order to stably maintain the toughness of the pearlite structure, the P content is desirably 0.0050 to 0.0150%.

$$( S \leq 0.03 \% )$$

S is an impurity element contained in steel. When the S content is more than 0.0300%, stress concentration is generated around a coarse MnS-based sulfide inclusion, and the breakage resistance of the weld joint portion 12 is deteriorated. Therefore, the S content is limited to 0.0300% or less. The lower limit of the S content does not need to be limited, and may be, for example, 0%, but the lower limit of the S content may be about 0.0020% in consideration of the desulfurization ability in refining. The S content is preferably 0.0025% or more, 0.0030% or more, or 0.0050% or more. The S content is preferably 0.0250% or less, 0.0200% or less, or 0.0150% or less. In order to stably maintain the breakage resistance of the pearlite structure, the S content is desirably 0.0050 to 0.0150%.

The balance of the chemical composition of the rail that is the material of the welded rail contains iron and impurities. The impurity means, for example, a component mixed due to the raw materials such as ore or scrap, or various factors in manufacturing when the steel material is industrially manufactured, and is acceptable within a range not adversely affecting the welded rail 1 according to the embodiment.

Furthermore, in order to improve wear resistance due to an increase in the hardness of the weld joint portion 12, improve toughness, prevent softening of the heat-affected zone 12H, and control cross-sectional hardness distribution inside the head, the rail that is the material of the welded rail may include, as necessary, one or more elements of Group a: Cr and Mo; Group b: Co; Group c: B; Group d: one or two of Cu and Ni; Group e: one or more of V, Nb, and Ti; Group f: one or more of Mg, Ca, and REM; Group g: N; Group h: Zr; and Group i: Al. However, even if these elements are not contained in the rail, the manufacturing method of the welded rail 1 according to the embodiment can exert its effect, and thus the lower limit of the content of these elements is 0%.

<Group a>

### (Cr: Preferably 2.00% or Less)

Cr is an element that increases the equilibrium transformation temperature, makes the lamellar interval of the pearlite structure refine by increasing the degree of supercooling, improves the hardness of the pearlite structure, and improves the wear resistance of the weld joint portion 12. In order to sufficiently obtain such an effect, the amount of Cr is preferably 0.03% or more, or 0.05% or more. On the other hand, when the amount of Cr exceeds 2.00%, an excessive amount of Cr may promote the Cr enrichment in the segregation portion, promote the formation of a martensite structure in the weld joint portion, and reduce the breakage resistance. Therefore, the Cr content is desirably 0.05 to 2.00%. The Cr content is preferably 0.06% or more, 0.08% or more, or 0.10% or more. The Cr content is preferably 1.80% or less, 1.50% or less, or 1.20% or less. Therefore, in order to stabilize the formation of the pearlite structure and improve the wear resistance and damage resistance of the weld joint portion 12, the Cr content is desirably 0.10 to 1.20%.

### (Mo: Preferably 0.50% or Less)

Mo is an element that increases the equilibrium transformation temperature, refines the lamellar interval of the pearlite structure by increasing the degree of supercooling, improves the hardness of the pearlite structure, and improves the wear resistance of the weld joint portion 12. In order to obtain the above-described effect, the amount of Mo is preferably 0.01% or more. On the other hand, when the amount of Mo exceeds 0.50%, an excessive amount of Mo may promote the Mo enrichment in the segregation portion, promote the formation of a martensite structure in the weld joint portion 12, and reduce the breakage resistance. Therefore, the Mo content is desirably 0.01 to 0.50%. The Mo content is preferably 0.02% or more, 0.05% or more, or 0.10% or more. The Mo content is preferably 0.45% or less, 0.40% or less, or 0.30% or less. Therefore, in order to stably improve the hardness of the pearlite structure and improve the wear resistance and damage resistance of the weld joint portion 12, the Mo content is desirably 0.10 to 0.30%.

<Group b>

### (Co: Preferably 1.00% or Less)

Co is an element that is solid-solved in a ferrite phase having a pearlite structure, refines the lamellar structure of the pearlite structure immediately below the rolling surface where deformation occurs due to contact with a wheel, improves the hardness of the rolling surface, and improves the wear resistance of the weld joint portion 12. In order to obtain the above-described effect, the amount of Co is preferably 0.01% or more. On the other hand, when the amount of Co is more than 1.00%, the above effect is saturated, and refinement of the lamellar structure according to the Co content cannot be achieved. In addition, when the amount of Co exceeds 1.00%, economic efficiency may be deteriorated due to an increase in alloy cost. Therefore, the Co content is desirably 0.01 to 1.00%. The Co content is preferably 0.02% or more, 0.05% or more, or 0.10% or more. The Co content is preferably 0.90% or less, 0.80% or less, or 0.60% or less. Therefore, in order to stably improve the wear resistance of the pearlite structure and improve the wear resistance of the weld joint portion 12, the Co content is desirably 0.10 to 0.60%.

<Group c>

### (B: Preferably 0.0050% or Less)

B is an element that forms an iron borocarbide (Fe₂₃(CB)₆) at an austenite grain boundary, reduces the cooling rate dependency of the pearlite transformation temperature by the effect of promoting pearlite transformation, uniformizes the hardness distribution from the head surface to the inside of the weld joint portion 12, and improves the wear resistance to increase the life of the weld joint portion 12. In order to obtain the above-described effect, the amount of B is preferably 0.0001% or more. On the other hand, when the amount of B is more than 0.0050%, a coarse iron borocarbide is formed, brittle fracture is promoted, and the breakage resistance of the weld joint portion 12 may be deteriorated. Therefore, the B content is desirably 0.0001 to 0.0050%. The B content is preferably 0.0002% or more, 0.0003% or more, or 0.0005% or more. The B content is preferably 0.0040% or less, 0.0030% or less, or 0.0025% or less. Therefore, in order to stably maintain the toughness of the pearlite structure and improve the wear resistance of the weld joint portion 12, the B content is desirably 0.0005 to 0.0025%.

<Group d>

### (Cu: Preferably 1.00% or Less)

Cu is an element that is solid-solved in a ferrite phase having a pearlite structure, improves the hardness of the weld joint portion 12 by solid solution strengthening, and improves the wear resistance of the weld joint portion 12. In order to obtain the above-described effect, the amount of Cu is preferably 0.01% or more. On the other hand, when the amount of Cu exceeds 1.00%, an excessive amount of Cu may promote the Cu enrichment in the segregation portion, promote the formation of a martensite structure in the weld joint portion 12, and reduce the breakage resistance. Therefore, the Cu content is preferably 0.01 to 1.00%. The Cu content is preferably 0.02% or more, 0.05% or more, or 0.10% or more. The Cu content is preferably 0.90% or less, 0.80% or less, or 0.70% or less. Therefore, in order to stably maintain the toughness of the pearlite structure and improve the wear resistance of the weld joint portion 12, the Cu content is desirably 0.10 to 0.70%.

### (Ni: Preferably 1.00% or Less)

Ni is an element that improves the toughness of the pearlite structure, and at the same time, improves the hardness of the weld joint portion 12 by solid solution strengthening, and improves the wear resistance of the weld joint portion 12. Further, in the heat-affected zone, Ni is an element that combines with Ti, precipitates as a fine intermetallic compound of Ni₃Ti, and suppresses softening of the weld joint portion 12 by precipitation strengthening. When Cu is contained in the rail, Ni suppresses embrittlement of the grain boundary. In order to obtain the above-described effect, the amount of Ni is preferably 0.01% or more. When the amount of Ni exceeds 1.00%, an excessive amount of Ni may promote the Ni enrichment in the segregation portion, promote the formation of a martensite structure in the weld joint portion 12, and reduce the breakage resistance. Therefore, the Ni content is desirably 0.01 to 1.00%. The Ni content is preferably 0.02% or more, 0.05% or more, or 0.10% or more. The Ni content is preferably 0.90% or less, 0.80% or less, or 0.70% or less. Therefore, in order to stably maintain the toughness of the pearlite structure and improve the wear resistance of the weld joint portion 12, the Ni content is desirably 0.10 to 0.70%.

<Group e>

### (V: Preferably 0.200% or Less)

V is an element that increases the hardness (strength) of the pearlite structure and improves the fatigue damage resistance of the weld joint portion 12 by precipitation hardening by a carbide/nitride of V formed in a cooling process after hot rolling. In order to obtain the above-described effect, the amount of V is preferably 0.005% or more. On the other hand, when the amount of V exceeds 0.200%, the number of fine carbides/nitrides of V is excessive, the pearlite structure is embrittled, and the breakage resistance of the weld joint portion 12 may be deteriorated. Therefore, the V content is desirably 0.005 to 0.200%. The V content is preferably 0.010% or more, 0.015% or more, or 0.020% or more. The V content is preferably 0.180% or less, 0.150% or less, or 0.100% or less. Therefore, in order to stably maintain the breakage resistance of the weld joint portion 12 and improve the fatigue damage resistance of the weld joint portion 12, the V content is desirably 0.020 to 0.100%.

### (Nb: Preferably 0.0500% or Less)

Nb is an element that increases the hardness of the pearlite structure and improves the fatigue damage resistance of the weld joint portion 12 by precipitation hardening by an Nb carbide and an Nb nitride formed in the cooling process after hot rolling when the rail is manufactured. In the heat-affected zone 12H reheated to a temperature range equal to or lower than the Ac1 point, Nb is an element effective for stably forming an Nb carbide, an Nb nitride, and the like in a wide temperature range from a low temperature range to a high temperature range and preventing softening of the heat-affected zone 12H of the weld joint portion 12. In order to obtain the above-described effect, the amount of Nb is preferably 0.0010% or more. On the other hand, when the amount of Nb exceeds 0.0500%, precipitation hardening of a carbide, a nitride, and the like of Nb becomes excessive, the pearlite structure itself embrittles, and the breakage resistance of the weld joint portion 12 may be deteriorated. Therefore, the Nb content is desirably 0.0010 to 0.0500%. The Nb content is preferably 0.0020% or more, 0.0025% or more, or 0.0030% or more. The Nb content is preferably 0.0400% or less, 0.0300% or less, or 0.0200% or less. Therefore, in order to stably maintain the breakage resistance of the weld joint portion 12 and improve the fatigue damage resistance of the weld joint portion 12, the V content is desirably 0.0030 to 0.0200%.

### (Ti: Preferably 0.0500% or Less)

Ti is an element that increases the hardness of the pearlite structure and improves the fatigue damage resistance of the weld joint portion 12 by precipitation hardening by a Ti carbide and a Ti nitride formed in the cooling process after hot rolling when the rail is manufactured. In addition, Ti is an element for refining the microstructure of the heat-affected zone 12H reheated to the austenite region and improving the breakage resistance of the weld joint portion 12 by utilizing the fact that the Ti carbide and the Ti nitride precipitated in reheating after welding do not dissolve in the matrix. In order to obtain the above-described effect, the amount of Ti is preferably 0.0010% or more, or 0.0060% or more. On the other hand, when the amount of Ti exceeds 0.0500%, coarse Ti carbide and Ti nitride are formed, and a fatigue crack is likely to be formed due to stress concentration around these, and the fatigue damage resistance of the weld joint portion 12 may be deteriorated. Therefore, the Ti content is desirably 0.0040 to 0.0500%. The Ti content is preferably 0.0040% or more, 0.0050% or more, or 0.0060% or more. The Ti content is preferably 0.0400% or less, 0.0300% or less, or 0.0200% or less. Therefore, in order to improve the fatigue damage resistance and the breakage resistance of the weld joint portion 12, the Ti content is desirably 0.0060 to 0.0200%.

<Group f>

### (Mg: Preferably 0.0200% or Less)

Mg is an element that combines with S to form fine sulfide (MgS), which finely disperses MnS and relaxes stress concentration around MnS, and improves fatigue damage resistance of the weld joint portion 12. In order to obtain the above-described effect, the amount of Mg is preferably 0.0005% or more. On the other hand, when the amount of Mg exceeds 0.0200%, a coarse oxide of Mg is formed, and a fatigue crack is easily formed due to stress concentration around the coarse oxide, and the fatigue damage resistance of the weld joint portion 12 may be deteriorated. Therefore, the amount of Mg is desirably 0.0005 to 0.0200%. The Mg content is preferably 0.0010% or more, 0.0015% or more, or 0.0030% or more. The Mg content is preferably 0.0180% or less, 0.0150% or less, or 0.0120% or less. Therefore, in order to improve the fatigue damage resistance of the weld joint portion 12, the Mg content is desirably 0.0030 to 0.0120%.

### (Ca: Preferably 0.0200% or Less)

Ca is an element that has a strong bonding force with S and forms a sulfide (CaS), which finely disperses MnS and relaxes stress concentration around MnS, and improves fatigue damage resistance of the weld joint portion 12. In order to obtain the above-described effect, the amount of Ca is preferably 0.0005% or more. On the other hand, when the amount of Ca exceeds 0.0200%, a coarse oxide of Ca is formed, and a fatigue crack is easily formed due to stress concentration around the coarse oxide, so that the fatigue damage resistance of the weld joint portion 12 may be deteriorated. Therefore, the amount of Ca is desirably 0.0005 to 0.0200%. The Ca content is preferably 0.0010% or more, 0.0020% or more, or 0.0030% or more. The Ca content is preferably 0.0180% or less, 0.0150% or less, or 0.0120% or less. Therefore, in order to improve the fatigue damage resistance of the weld joint portion 12, the Ca content is desirably 0.0030 to 0.0120%.

### (REM: Preferably 0.0500% or Less)

REM is a deoxidation and desulfurization element, generates oxysulfide (REM₂O₂S) of REM, and becomes a formation nucleus of Mn sulfide-based inclusions. Since oxysulfide (REM₂O₂S) has a high melting point, stretching of the Mn sulfide-based inclusion after rolling is suppressed. As a result, REM finely disperses MnS, relaxes stress concentration around MnS, and improves the fatigue damage resistance of the weld joint portion 12. In order to obtain the above-described effect, the REM amount is preferably 0.0005% or more. On the other hand, when the amount of REM is more than 0.0500%, coarse and hard oxysulfide of REM (REM₂O₂S) is formed, and stress concentration around the oxysulfide easily generates a fatigue crack, so that the fatigue damage resistance of the weld joint portion 12 may be deteriorated. Therefore, the REM content is desirably 0.0005 to 0.0500%. The REM content is preferably 0.0010% or more, 0.0020% or more, or 0.0030% or more. The REM content is preferably 0.0400% or less, 0.0300% or less, or 0.0250% or less. Therefore, in order to improve the fatigue damage resistance of the weld joint portion 12, the REM content is desirably 0.0030 to 0.0250%.

Note that REM is the total of 17 elements including Sc, Y, and La (lanthanoid). The “REM content” means the total content of all these REM elements. When the total content is within the above range, the same effect can be obtained regardless of whether the number of types of REM elements is one or two or more.

<Group g>

### (N: Preferably 0.0200% or Less)

N is an element that can be mixed into the rail as an impurity in the steelmaking process. Even when degassing is actively performed, about 0.0025% of N may remain in the steel. In normal rail refining, the N content is about 0.0030 to 0.0050%. The N content can be less than 0.0025%, but N may be contained in an amount of 0.0025% or more in the rail in order to avoid an increase in refining cost. In addition, N is an element effective for promoting pearlite transformation from an austenite grain boundary by segregating at the austenite grain boundary, and improving the toughness of the weld joint portion 12 mainly by refining the pearlite block size. When N and V are simultaneously contained, precipitation of carbonitride of V is promoted in a cooling process of the weld joint portion 12 after welding of the rail, the hardness of a pearlite structure is increased, and the fatigue damage resistance of the weld joint portion 12 is improved. In order to obtain the above-described effect, the amount of N is preferably 0.0060% or more. On the other hand, when the amount of N is more than 0.0200%, it is difficult to solid-solve N in steel, and bubbles as the starting point of fatigue damage may be likely to be formed. Therefore, the N content is desirably 0.0060 to 0.0200%. The N content is preferably 0.0060% or more, 0.0070% or more, or 0.0080% or more. The N content is preferably 0.0180% or less, 0.0160% or less, or 0.0150% or less. Therefore, in order to stably improve toughness and fatigue damage resistance, the N content is desirably 0.0080 to 0.0150%.

<Group h>

### (Zr: Preferably 0.0200% or Less)

Zr forms a ZrO₂ inclusion having good lattice matching with γ-Fe, and thus, γ-Fe serves as a solidification nucleus of the high carbon rail steel that is a solidification primary phase, and suppresses the formation of a segregation band at the central part of the cast piece and suppresses the alloy enrichment in the segregated portion by increasing the equiaxed crystal ratio of the solidified microstructure. As a result, Zr suppresses the formation of the martensite structure of the weld joint portion 12, and improves the breakage resistance and the fatigue damage resistance. In order to obtain the above-described effect, the amount of Zr is preferably 0.0001% or more. On the other hand, when the amount of Zr is more than 0.0200%, a large amount of coarse Zr-based inclusions are formed, and due to stress concentration around the coarse inclusions, fatigue cracks are easily generated, and the fatigue damage resistance of the weld joint portion 12 may be deteriorated. Therefore, the Zr content is desirably 0.0001 to 0.0200%. The Zr content is preferably 0.0005% or more, 0.0010% or more, or 0.0015% or more. The Zr content is preferably 0.0180% or less, 0.0150% or less, or 0.0120% or less. Therefore, in order to stably improve breakage resistance and fatigue damage resistance, the Zr content is desirably 0.0015 to 0.0120%.

<Group i>
(Al: preferably 1.0000% or less)

Al is a component that functions as a deoxidation material. In order to obtain the above-described effect, the amount of Al is preferably 0.0005% or more, or 0.0010% or more. On the other hand, when the amount of Al is more than 1.0000%, coarse alumina-based inclusions are formed, fatigue cracks are likely to be formed from the coarse inclusions, and the fatigue damage resistance of the weld joint portion 12 may be deteriorated. Furthermore, when the amount of Al exceeds 1.0000%, an oxide is formed during welding of the rail, and the weldability of the rail may be significantly deteriorated. Therefore, the Al content is desirably 0.0005 to 1.0000%. The Al content is preferably 0.5000% or less, 0.4000% or less, or 0.3000% or less. Therefore, in order to stably perform deoxidation, the Al content is desirably 0.0005 to 0.3000%.

### (2) Reasons for Limitation of Cooling Stop Temperature (TC) of Outline Surface of Corner Portion on Head Top 1214 in Welding Center a of Weld Joint Portion 12

The manufacturing method of the welded rail 1 according to the embodiment includes cooling the weld joint portion 12, which is obtained by subjecting rails to flash butt welding, immediately after the flash butt welding is completed. The forced cooling enhances the hardness of the weld joint portion 12 to improve the wear resistance of the weld joint portion 12. However, excessive forced cooling causes the weld joint portion 12 to produce martensite. Therefore, the forced cooling conditions need to be appropriately managed.

As described above, the forced cooling means that a refrigerant such as air, water, and mist is sprayed to the weld joint portion 12. Examples of the forced cooling include air cooling, water cooling, and gas-water cooling. Radiational cooling is regarded as a concept different from forced cooling.

In both of the forced cooling and the radiational cooling cases, the cooling rate after flash butt welding was affected by the amount of heat input in flash butt welding and the HAZ width formed by flash butt welding. As the HAZ width was larger, the cooling rate tended to be slower. When rails were subjected to flash butt welding to manufacture a weld joint portion and the weld joint portion was thereafter subjected to radiational cooling, the average cooling rate of the outline surface of the head top corner was usually in a range of about 1.0 to 2.0° C./sec within a temperature range of 900° C. to 600° C. On the other hand, when rails were subjected to flash butt welding to manufacture a weld joint portion and the weld joint portion was thereafter subjected to air cooling, the average cooling rate of the outline surface of the head top corner is usually in a range of about 1.5 to 5.0° C./sec within a temperature range from 900° C. to 600° C. When the cross-sectional shape of the rail to be welded and the conditions for flash butt welding were constant, the cooling rate of the radiational cooling was necessarily lower than the cooling rate of the forced cooling. The “average cooling rate V within a temperature range from X° C. to Y° C.” is a value calculated by the following formula when the time required to decrease the temperature of a cooling object from X° C. to Y° C. is defined as t.

$$V = ( X - Y ) / t$$

The average cooling rate can be measured using a radiation thermometer. The radiation thermometer can measure the temperature of the surface of an object in a contactless manner.

In the embodiment, the description “subjecting the weld joint portion to forced cooling immediately after the flash butt welding is completed” means that forced cooling is started in 5 sec or more and 30 sec or less after the flash butt welding is completed. As described above, the time when flash butt welding is completed means the time when trimming is completed. After the flash butt welding is completed, a cooling device is installed at the weld joint portion to start cooling, which usually requires 5 sec or more. When the forced cooling is started more than 30 sec after the flash butt welding is completed, pearlite transformation may start in a high temperature range before the forced cooling such that the hardness of the weld joint portion is impaired.

In the forced cooling of the weld joint portion 12, the cooling stop temperature (TC) of the outline surface of the head top corner 1214 in the welding center A and the cooling stop temperature (TA) of the outline surface of the head jaw 1212 in the welding center A are independently controlled. Hereinafter, description will be made about the reason why the manufacturing method of the welded rail 1 according to the embodiment includes the limitation: when the forced cooling is performed from an austenite temperature range after the flash butt welding is completed, in the welding center A of the weld joint portion 12, the cooling stop temperature (TC) of the outline surface of the head top corner 1214 is 560° C. or higher.

As shown in FIG. 9, when the cooling stop temperature (TC) of the outline surface of the head top corner 1214 is lower than 560° C., the number of martensite structures generated in the martensite structure evaluation region C located near the head jaw is more than 10, and the weld joint portion 12 cannot be prevented from breakage as shown in FIG. 7. Therefore, the cooling stop temperature (TC) of the outline surface of the head top corner 1214 is limited to 560° C. or higher. TC may be 580° C. or higher, 600° C. or higher, 620° C. or higher, or 650° C. or higher. Although it is not necessary to limit the upper limit of TC, for example, TC may be 850° C. or lower, 800° C. or lower, 750° C. or lower, or 720° C. or lower. In order to stably control the number of martensite structures generated in the martensite structure evaluation region C to 10 or less, the cooling stop temperature (TC) is desirably controlled to 600° C. or higher and 750° C. or lower.

The cooling start temperature in the forced cooling from the austenite temperature range is not particularly limited, but there is no problem as long as it is in an austenite temperature range. Immediately after the flash butt welding of the rails is completed, the temperature of the outline surface of the head top corner 1214 is about 1200° C., and therefore the upper limit of the austenite temperature range is substantially 1200° C. in the embodiment.

In addition, the austenite temperature range varies depending on the carbon amount and the alloy component of the rail. In order to accurately determine the austenite temperature range, it is most preferable to directly measure the transformation point by a reheating and cooling experiment or the like. However, since actual measurement is not necessarily easy, the austenite temperature range may be easily determined by reading the equilibrium state diagram of the Fe—Fe₃C system based only on the carbon amount.

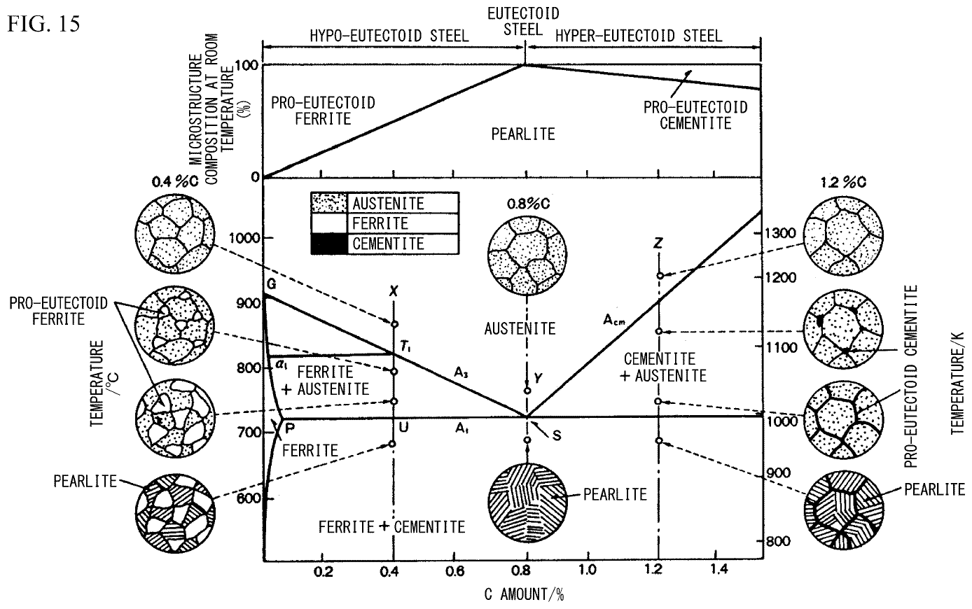

For example, FIG. 15 shows the state diagram of the Fe—Fe₃C system cited from Izumi Osamu, et al., “Course-Present metallography, Materials edition, Vol. 4, Iron and Steel Materials”, 2nd edition, The Japan Institute of Metals and Materials, December 1985, p. 19. The austenite temperature range in the component system of the rail is a region on the higher temperature side than the A3 line and the Acm line in the parallel phase diagram. In the range of the carbon amount of the rail described above, Ar3 is about 715° C. to 750° C., and Arcm is about 715° C. to 900° C. The line A3 is a solubility line of the ferrite phase against the austenite phase, and the line Acm is a solubility line of the cementite phase against the austenite phase.

### (3) Reasons for Limitation of Cooling Stop Temperature (TA) of Outline Surface of Jaw Portion on Head 1212 in Welding Center A of Weld Joint Portion 12

Next, description will be made about the reason why the embodiment includes the limitation: when the forced cooling is performed from an austenite temperature range after the flash butt welding is completed, in the welding center A of the weld joint portion 12, the cooling stop temperature (TA) of the outline surface of the head jaw 1212 is 650° C. or higher.

As shown in FIG. 10, when the cooling stop temperature (TA) of the outline surface of the head jaw 1212 is lower than 650° C., the number of martensite structures generated in the martensite structure evaluation region C located near the outline surface of the head jaw 1212 is more than 10, and the weld joint portion 12 cannot be prevented from breakage as shown in FIG. 7. Therefore, the cooling stop temperature (TA) of the outline surface of the head jaw 1212 is limited to 650° C. or higher. TA may be 680° C. or higher, 700° C. or higher, 720° C. or higher, or 750° C. or higher. Although it is not necessary to limit the upper limit of TA, for example, TA may be 950° C. or lower, 900° C. or lower, 850° C. or lower, or 820° C. or lower. In order to stably control the number of martensite structures generated in the martensite structure evaluation region C to 10 or less, the cooling stop temperature (TA) is desirably controlled to 670° C. or higher and 850° C. or lower.

After the forced cooling is stopped, the weld joint portion 12 is subjected to radiational cooling. When the weld joint portion 12 is subjected to forced cooling again after the forced cooling is stopped, martensite may be generated in the weld joint portion 12. The weld joint portion 12 is preferably left in the atmosphere until its temperature reaches room temperature. When the forced cooling is stopped at a temperature of 600° C. or higher and then the weld joint portion 12 is subjected to radiational cooling, the average cooling rate of the outline surface of the head top corner is usually about 0.5° C./sec within a temperature range from 600° C. to 200° C.

The cooling start temperature in the forced cooling from the austenite temperature range is not particularly limited, but there is no problem as long as it is in an austenite temperature range. The austenite temperature range is specified as described above.

### (4) Desirable Temperature Control Method for Head Outline Surface in Welding Center A Of Weld Joint Portion 12

Next, description will be made about how to perform control in the embodiment so that when the forced cooling is performed from an austenite temperature range after the flash butt welding is completed, in the welding center A of the weld joint portion 12, the cooling stop temperature (TC) of the outline surface of the head top corner 1214 is 560° C. or higher; and the cooling stop temperature (TA) of the outline surface of the head jaw 1212 is 650° C. or higher.

Generally, the rail head is subjected to forced cooling by using a method of injecting a refrigerant such as air to the outline surface of the head top 1211, the outline surface of the head top corner 1214, and the outline surface of the head side 1213 illustrated in FIG. 2. The cooling stop temperature (TC) of the outline surface of the head top corner 1214 is adjusted mainly by controlling the injection amount of the refrigerant to be sprayed to the outline surface of the head top 1211 and the outline surface of the head top corner 1214. The cooling stop temperature (TA) of the outline surface of the head jaw 1212 is adjusted mainly by controlling the injection amount of the refrigerant to be sprayed to the outline surface of the head side 1213.

When the injection amount of the refrigerant cannot be controlled, the cooling stop temperature (TC) of the outline surface of the head top corner 1214 and the cooling stop temperature (TA) of the outline surface of the head jaw 1212 can be controlled, respectively, by adjusting the distance between the refrigerant injection hole and the outline surfaces in the outline surface of the head top 1211, the outline surface of the head top corner 1214, and the outline surface of the head side 1213.

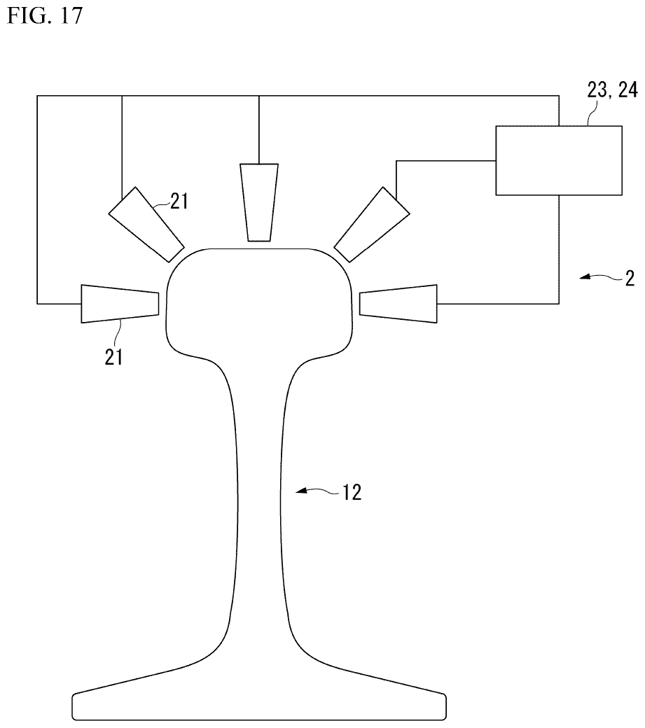

The device for performing cooling in the above-described procedure is not particularly limited. For example, a cooling device 2 illustrated in FIG. 17 may be used as a cooling means for the welded rail 1 according to the embodiment. The cooling device 2 includes a rail installation portion, a plurality of refrigerant injection means 21 each having a refrigerant injection hole, a refrigerant supply means 23, and a control means 24.

The rail installation portion is configured such that the weld joint portion 12 of the welded rail 1 can be arranged. FIG. 17 discloses a state in which the weld joint portion 12 of the welded rail 1 is arranged in the rail installation portion. The cooling device 2 may include a driver for moving the welded rail 1 arranged in the rail installation portion in the longitudinal direction thereof. As a result, a plurality of the weld joint portions 12 provided in the welded rail 1 can be continuously cooled.

The plurality of refrigerant injection means 21 is arranged to surround the rail installation portion. The refrigerant injection direction of the refrigerant injection means 21 is directed to the rail installation portion. The refrigerant injection means 21 may be configured such that the place to install the same can be changed. The refrigerant injection means 21 may be configured such that the refrigerant injection direction thereof can be changed. As a result, the cooling device 2 can be used for the welded rails 1 having various shapes.

It is preferable that the cooling device 2 does not inject a refrigerant toward the column 122 of the weld joint portion 12. The refrigerant injected to the column 122 partly flows to the outline surface of the head jaw 1212 of the weld joint portion 12 and lowers the temperature of the outline surface of the head jaw 1212. As a result, there is a possibility that the cooling stop temperature (TA) of the outline surface of the head jaw 1212 is excessively lowered, and the relationship of TA≥TC is not satisfied. Therefore, the cooling device 2 preferably omits a refrigerant injection means 21 that is positioned to inject a refrigerant toward the column 122. When the cooling device 2 has a refrigerant injection means 21 that is positioned to inject a refrigerant toward the column 122, the injection amount of the refrigerant to the column 122 is preferably suppressed by using the control means 24 described below.

The refrigerant supply means 23 supplies a refrigerant to the refrigerant injection means 21. The control means 24 is configured such that the refrigerant injection means 21 starts and stops injecting a refrigerant. The control means 24 can independently control the start and stop of injecting a refrigerant in each of the plurality of refrigerant injection means 21.

It is extremely important for controlling the cooling conditions of the weld joint portion 12 as described above to use the control means 24 and/or the refrigerant injection means 21 and optimize the injection amount of the refrigerant. It is necessary that the interval between the refrigerant injection means 21 and the weld joint portion 12 is in a predetermined range, or the injection amount of the refrigerant is independently set for each of the plurality of refrigerant injection means 21. Therefore, it is preferable that the control means 24 can independently control the injection amount of the refrigerant for each of the plurality of refrigerant injection means 21. As a result, the cooling stop temperature can be preferably controlled as described above. When the control means cannot control the injection amount of the refrigerant, it is necessary that the arrangement of the refrigerant injection means 21 is changed to adjust the distance between the refrigerant injection holes and the outline surfaces so that the cooling stop temperature is preferably controlled as described above.

When the weld joint portion 12 is cooled using a cooling device 2 provided with no temperature measurement means, the method for measuring the cooling stop temperature and the average cooling rate is as follows.

(A) After the flash butt welding is completed and immediately before the cooling device is arranged, the temperatures of the outline surface of the head top corner and the outline surface of the head jaw in the weld joint portion 12 are measured by using a radiation thermometer. The temperatures are the cooling start temperature of the outline surface of the head top corner and the cooling start temperature of the outline surface of the head jaw.

(B) The weld joint portion 12 is placed in the rail installation portion of the cooling device. The weld joint portion 12 may be placed where the cooling device is stopped and the weld joint portion 12 is moved. On the other hand, the weld joint portion 12 may be placed where the weld joint portion 12 is stopped and the cooling device is moved. In any case, it takes about 5 to 10 seconds to place the weld joint portion 12 in the cooling device and start cooling.

(C) The weld joint portion 12 is cooled.

(D) After the cooling is completed, the cooling device is removed from the weld joint portion 12. When the cooling device is removed, the weld joint portion 12 may be moved, or the cooling device may be moved. In any case, it takes about 5 to 10 seconds to remove the cooling device from the weld joint portion 12.

(E) Immediately after the cooling device is removed from the weld joint portion 12, the temperatures of the outline surface of the head top corner and the outline surface of the head jaw in the weld joint portion 12 are measured by using a radiation thermometer. The temperatures are the cooling stop temperature (TC) of the outline surface of the head top corner and the cooling stop temperature (TA) of the outline surface of the head jaw. (F) The difference between the cooling start temperature and the cooling stop temperature is divided by the time required from the first temperature measurement (A) to the second temperature measurement (E), thereby calculating the average cooling rate.

The temperature measurement procedure described above is applied to a cooling device 2 provided with no temperature measurement means. On the other hand, the cooling device 2 may further include a temperature measurement means that is connected to the control means 24 and arranged to face the rail installation portion. The temperature measurement means is a radiation thermometer. The radiation thermometer can measure the surface temperature of an object. When the temperature measurement means provided to the cooling device 2 is used, the cooling conditions of the weld joint portion 12 can be accurately controlled depending on the temperature of the weld joint portion 12. When the cooling device 2 is provided with a temperature measurement means, cooling is desirably started 5 to 10 seconds after the cooling start temperature measurement is completed. The cooling stop temperature is desirably measured 5 to 10 seconds after the cooling is completed.

However, when the shape of the weld joint portion 12 and the flash butt welding conditions are constant, the temperature distribution of the weld joint portion 12 arranged in the rail installation portion is also substantially constant such that the weld joint portion 12 can be cooled under the same refrigerant injection conditions. Therefore, when the refrigerant injection conditions are determined in advance such that the cooling conditions are within the scope of the manufacturing method according to the embodiment, temperature measurement using a temperature measurement means is unnecessary.

(5) Reasons why TA≥TC (that is, 0≤TA−TC) is Preferred

Next, description will be given regarding the reason why it is preferable to perform control in the manufacturing method of the embodiment such that when the forced cooling is performed from an austenite temperature range after the flash butt welding is completed, in the welding center A of the weld joint portion 12, the cooling stop temperature (TC) of the outline surface of the head top corner 1214 and the cooling stop temperature (TA) of the outline surface of the head jaw 1212 satisfy the relationship of TA≥TC.

The rail head is subjected to forced cooling by using a method of injecting a refrigerant such as air to the outline surface of the head top 1211, the outline surface of the head top corner 1214, and the outline surface of the head side 1213 illustrated in FIG. 2. However, when the outline surface of the head jaw 1212 is excessively cooled, martensite may be generated in the weld joint portion 12. In particular, in a case of TA<TC, martensite tends to be easily generated in the weld joint portion 12. For the above reason, it is determined that TA≥TC is preferable. For example, the relationship of TA≥TC is easily satisfied when spraying a refrigerant toward the column 122 of the weld joint portion 12 is suppressed.

### (6) Reasons why TA+TC≥1340 is Preferred

Next, description will be given regarding the reason why it is preferable to perform control in the manufacturing method of the embodiment such that when the forced cooling is performed from an austenite temperature range after the flash butt welding is completed, in the welding center A of the weld joint portion 12, the cooling stop temperature (TC) of the outline surface of the head top corner 1214 and the cooling stop temperature (TA) of the outline surface of the head jaw 1212 satisfy the relationship of TA+TC≥1340.

As shown in FIG. 11, when the sum of the cooling stop temperature (TA) of the outline surface of the head jaw 1212 and the cooling stop temperature (TC) of the outline surface of the head top corner 1214 is 1340° C. or higher, the temperatures of the outline surface of the head top corner 1214 and the outline surface of the head jaw 1212 are secured, the cooling rate of the outline surface of the head jaw 1212 is relaxed during the radiational cooling process after cooling is stopped, the number of martensite structures generated in the martensite structure evaluation region C near the head jaw is 5 or less as shown in FIG. 8, and the breakage resistance of the weld joint portion 12 can be further improved. Therefore, TA+TC≥1340 is preferable. In order to stably control the number of martensite structures generated in the martensite structure evaluation region C to 5 or less, TA+TC is further desirably controlled to 1360° C. or higher and 1500° C. or lower.

### (7) Reasons why 0≤TA−TC≤140 is Preferred

Next, description will be made about the reason why it is preferable to perform control in the manufacturing method of the embodiment so that when the forced cooling is performed from an austenite temperature range after the flash butt welding is completed, in the welding center A of the weld joint portion 12, the cooling stop temperature (TC) of the outline surface of the head top corner 1214 and the cooling stop temperature (TA) of the outline surface of the head jaw 1212 satisfy the relationship of 0≤TA−TC≤140.

As shown in FIG. 12, when the difference of the cooling stop temperature (TA) of the outline surface of the head jaw 1212 and the cooling stop temperature (TC) of the outline surface of the head top corner 1214 is controlled to 140° C. or lower, the temperature difference between the outline surface of the head top corner 1214 and the outline surface of the head jaw 1212 is reduced, the cooling rate of the outline surface of the head jaw 1212 is relaxed during the radiational cooling process in the head jaw where the martensite structure is generated, the number of martensite structures generated in the martensite structure evaluation region C near the head jaw is 5 or less as shown in FIG. 9, and the breakage resistance of the weld joint portion 12 is further improved. Therefore, TA−TC≤140 is preferable. In order to stably control the number of martensite structures generated in the martensite structure evaluation region C to 5 or less, TA−TC is further desirably controlled to 20° C. or higher and 120° C. or lower. It is assumed that TA−TC is hardly lower than 0° C. as described below, and the lower limit of TA−TC is 0° C.

When the difference of the cooling stop temperature (TA) of the outline surface of the head jaw 1212 and the cooling stop temperature (TC) of the outline surface of the head top corner 1214 is in a range of 160 to 240° C., as shown in FIG. 13, the sum of the cooling stop temperature (TA) of the outline surface of the head jaw 1212 and the cooling stop temperature (TC) of the outline surface of the head top corner 1214 becomes 1340° C. or higher, but the number of generated martensite structures does not become 5 or less.

When the sum of the cooling stop temperature (TA) of the outline surface of the head jaw 1212 and the cooling stop temperature (TC) of the outline surface of the head top corner 1214 is in a range of 1250 to 1330° C., as shown in FIG. 14, the difference of the cooling stop temperature (TA) of the outline surface of the head jaw 1212 and the cooling stop temperature (TC) of the outline surface of the head top corner 1214 becomes 140° C. or lower, but the number of generated martensite structures does not become 5 or less.

In order that the number of generated martensite structures is controlled to 5 or less, it is preferable to control both the sum and difference of the cooling stop temperature (TA) of the outline surface of the head jaw 1212 and the cooling stop temperature (TC) of the outline surface of the head top corner 1214. In addition, it is preferable that both TA+TC≥1340 and 0≤TA−TC≤140 are satisfied.

### (8) Reasons for Limitation of Temperature Measurement Position of Outline Surface of Corner Portion on Head Top 1214 and Outline Surface of Jaw Portion on Head 1212 in Welding Center a of Weld Joint Portion 12

When the generation of the martensite structure is controlled in the martensite structure evaluation region C near the head jaw shown in FIG. 5, it is effective to control the temperature of the outline surface of the head jaw 1212, which is positioned near the same. In addition, the present inventors studied the temperature control position of the outline surface of the head jaw 1212 that affects the generation of the martensite structure, and found that the temperature of the outline surface of the head top corner 1214 and the generation amount of the martensite structure strongly correlate with each other, as shown in FIGS. 9, 11, and 12. Therefore, when the generation of the martensite structure is controlled in the martensite structure evaluation region C, it is effective to control the temperature of the outline surface of the head top corner 1214 in addition to the outline surface of the head jaw 1212.

In the manufacturing method of the welded rail 1 according to the embodiment, matters other than those described above are not particularly limited. For example, the flash butt welding conditions are not particularly limited. Welding conditions suitable for rails having the above-described chemical composition can be appropriately adopted. The cooling means for the weld joint portion 12 is not limited, either. Cooling means can be appropriately adopted such that the cooling stop temperature (TC) of the outline surface of the head top corner 1214 and the cooling stop temperature (TA) of the outline surface of the head jaw 1212 in the welding center A can be within the above range.

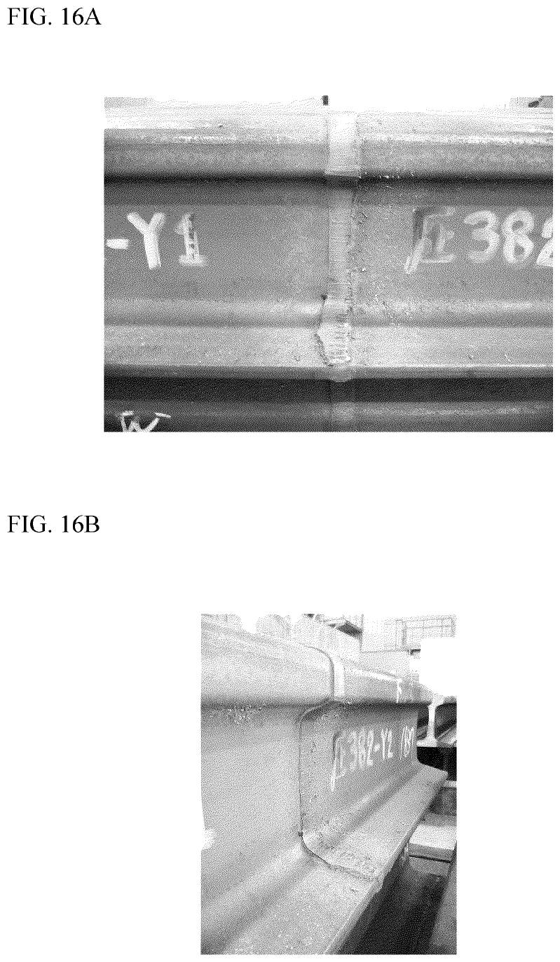

On the weld joint portion 12 immediately after flash butt welding, steel discharged from the weld in upsetting remains as excess metal. The excess metal is removed immediately after the welding is completed. However, as shown in FIGS. 16A and 16B, the excess metal may still partly remain in a thickness of several mm on the surface of the head jaw after the welding is completed, even after trimming (or bead cutting), which is an operation to remove the excess metal. It is necessary to specify the martensite structure evaluation region (C) based on the surface of the head jaw of the base metal rail, regardless of the remaining excess metal.

In addition, the metallographic structure of the martensite structure evaluation region C is preferably pearlite. It has been confirmed that a pearlite structure is the best to secure the wear resistance of the rail head not only in the region. Therefore, the head of the rail weld joint portion (the region from the head top surface to the ⅓ h depth) is preferably made of a pearlite structure for the part other than the martensite structure limited above. The other sites may be a metallographic structure other than the pearlite structure for the part other than the martensite structure limited above as long as the strength, ductility, and toughness necessary for the rail can be secured. In the manufacturing method of the welded rail according to the embodiment, the composition of the rails and the cooling stop temperature are within the above range, thereby the metallographic structure of the weld joint portion being made mainly of pearlite.

### EXAMPLES

The effect of an embodiment of the present invention is described more specifically with reference to examples. However, the conditions in the examples are merely one condition example adopted to confirm the operability and effects of the present invention. The present invention is not limited to this one condition example.

The present invention can adopt various conditions as long as the object of the present invention is achieved without departing from the gist of the present invention.

The present inventors produced welded rails under various conditions, and evaluated the breakage resistance thereof. The test conditions are as follows.

### Flash Butt Welding Conditions (Preheating Flash Method)

Initial flash time: 15 sec
Number of times of preheating: 10 times
Late flash time: 25 sec
Average late flash speed: 1.0 mm/see
Late flash speed immediately before upset (for 3 sec): 2.0 mm/see
Upset load: 65 KN
   Cooling Conditions of Weld Joint Portion after Welding
Site: Welding center (A)
Cooling start time: 15 sec after welding is completed
Cooling method: air
Cooling site: outline surface of head top 1211, outline surface of corner portion on head top 1214, and outline surface of head side 1213
Cooling after air cooling: radiational cooling (to 50° C.)

### Characteristics of Flash Butt Welding Joint Portion

HAZ width: 32 mm
Hardness of welding center: 390 to 440 HV
Hardness of most softened portion: 280 HV

### Evaluation of Martensite Structure

Evaluation site (see FIG. 5) means a region that ranges±5 mm (width 10 mm) from the welding center (A) in the longitudinal cross section of the weld joint portion and has a depth of 1 to 5 mm from the outline surface of the head jaw 1212 toward the outline surface of the head top corner (martensite structure evaluation region: C).

The reason for the selection of the evaluation site is because rail breakage occurs there starting from the martensite structure.

### Method for Revealing Martensite Structure

After the martensite structure evaluation region (C) is polished, Nital etching is performed, followed by observation with an optical microscope.
Polishing conditions: buffing with 1 μm diamond paste
Martensite etching conditions
Etching solution: alcohol+5% nitric acid (Nital)
Etching time: 5 to 10 seconds
Investigation method for microstructure
Apparatus: optical microscope
Magnification: 400 times

### Evaluation Method for Microstructure

The martensite structure that can be confirmed at a magnification of 400 times of the optical microscope was evaluated.

The target martensite structure had a long diameter of 25 to 100 μm, and when the martensite structure was generated, the number thereof was investigated.

### Falling Weight Test Conditions (See FIG. 6)

Attitude: The welded rail is supported at two points with the head on the lower side and the bottom on the upper side, and a falling weight is dropped to the bottom of the rail.
Span length (interval between two support points): 1000 mm
Weight of falling weight: 1000 kgf (9.8 kN)
Falling weight height (X): 5.0 and 7.5 m
Falling weight energy: 49.0 and 73.5 kN·m

The chemical compositions of the rails subjected to flash butt welding are shown in Tables 1A, 1B, 2A, 2B, 3A, and 3B. The cooling stop temperature (TC) of the outline surface of the head top corner and the cooling stop temperature (TA) of the outline surface of the head jaw are shown in Tables 4A and 4B.

For reference, Tables 4A and 4B also show the calculation results of TA+TC and TA−TC.

In addition, Tables 4A and 4B also show the number of martensite in the martensite structure evaluation region C of the welded rail and the evaluation results of the breakage resistance of the welded rail. The evaluation criteria were as follows.

### The Number of Martensite in the Martensite Structure Evaluation Region C

5 or less: A
More than 5 and 10 or less: B
More than 10: C

### Evaluation of Breakage Resistance

Not broken at a falling weight height of 7.5 m: A
Broken at a falling weight height of 7.5 m, but not broken at a falling weight height of 5.0 m: B
Broken at a falling weight height of 5.0 m: C

It was determined that when the breakage resistance was evaluated as “B” or “A”, the welded rail was excellent in breakage resistance.

TABLE 1A

| | C | Si | Mn | P | S |
|---|---|---|---|---|---|
| 1 | 1.00 | 0.80 | 0.70 | 0.0100 | 0.0100 |
| 2 | 1.20 | 0.70 | 0.80 | 0.0150 | 0.0080 |
| 3 | 0.70 | 0.70 | 0.80 | 0.0150 | 0.0080 |
| 4 | 0.80 | 2.00 | 0.60 | 0.0120 | 0.0100 |
| 5 | 0.80 | 0.05 | 0.60 | 0.0120 | 0.0100 |
| 6 | 0.85 | 0.40 | 2.00 | 0.0050 | 0.0140 |
| 7 | 0.85 | 0.40 | 0.05 | 0.0050 | 0.0140 |
| 8 | 0.95 | 1.20 | 0.40 | 0.0300 | 0.0100 |
| 9 | 0.95 | 1.20 | 0.40 | 0.0100 | 0.0300 |
| 10 | 1.10 | 0.50 | 1.20 | 0.0140 | 0.0050 |
| 11 | 1.10 | 0.50 | 1.20 | 0.0140 | 0.0050 |
| 12 | 1.05 | 1.00 | 0.60 | 0.0120 | 0.0110 |
| 13 | 1.05 | 1.00 | 0.60 | 0.0120 | 0.0110 |
| 14 | 1.05 | 1.00 | 0.60 | 0.0120 | 0.0110 |
| 15 | 1.05 | 1.00 | 0.60 | 0.0120 | 0.0110 |
| 16 | 1.05 | 1.00 | 0.60 | 0.0120 | 0.0110 |
| 17 | 1.05 | 1.00 | 0.60 | 0.0120 | 0.0110 |
| 18 | 1.05 | 1.00 | 0.60 | 0.0120 | 0.0110 |
| 19 | 1.05 | 1.00 | 0.60 | 0.0120 | 0.0110 |
| 20 | 1.05 | 1.00 | 0.60 | 0.0120 | 0.0110 |
| 21 | 1.05 | 1.00 | 0.60 | 0.0120 | 0.0110 |
| 22 | 1.05 | 1.00 | 0.60 | 0.0120 | 0.0110 |

TABLE 1B

| | C | Si | Mn | P | S |
|---|---|---|---|---|---|
| 23 | 1.05 | 1.00 | 0.60 | 0.0120 | 0.0110 |
| 24 | 1.05 | 1.00 | 0.60 | 0.0120 | 0.0110 |
| 25 | 1.05 | 1.00 | 0.60 | 0.0120 | 0.0110 |
| 26 | 1.05 | 1.00 | 0.60 | 0.0120 | 0.0110 |
| 27 | 1.05 | 1.00 | 0.60 | 0.0120 | 0.0110 |
| 28 | 1.05 | 1.00 | 0.60 | 0.0120 | 0.0110 |

| | |
|---|---|
| 29 | The same as in Example 1 |
| 30 | The same as in Example 1 |
| 31 | The same as in Example 1 |
| 32 | The same as in Example 1 |
| 33 | The same as in Example 1 |
| 34 | The same as in Example 1 |
| 35 | The same as in Example 1 |
| 36 | The same as in Example 1 |
| 37 | The same as in Example 1 |
| 38 | The same as in Example 1 |
| 39 | The same as in Example 1 |
| 40 | The same as in Example 1 |
| 41 | The same as in Example 1 |
| 42 | The same as in Example 1 |
| 43 | The same as in Example 1 |
| 44 | The same as in Example 1 |

TABLE 2A

| | Cr | Mo | Co | B | Cu | Ni | V | Nb |
|---|---|---|---|---|---|---|---|---|
| 1 | 0.03 | — | — | — | — | — | — | — |
| 2 | 0.03 | — | — | — | — | — | — | — |
| 3 | 0.03 | — | — | — | — | — | — | — |
| 4 | 0.02 | — | — | — | — | — | — | — |
| 5 | 0.02 | — | — | — | — | — | — | — |
| 6 | 0.01 | — | — | — | — | — | — | — |
| 7 | 0.01 | — | — | — | — | — | — | — |
| 8 | 0.02 | — | — | — | — | — | — | — |
| 9 | 0.02 | — | — | — | — | — | — | — |
| 10 | 2.00 | — | — | — | — | — | — | — |
| 11 | 0.10 | — | — | — | — | — | — | — |
| 12 | 0.03 | 0.50 | — | — | — | — | — | — |
| 13 | 0.03 | — | 1.00 | — | — | — | — | — |
| 14 | 0.03 | — | — | 0.0050 | — | — | — | — |
| 15 | 0.03 | — | — | — | 1.00 | — | — | — |
| 16 | 0.03 | — | — | — | — | 1.00 | — | — |
| 17 | 0.03 | — | — | — | — | — | 0.200 | — |
| 18 | 0.03 | — | — | — | — | — | — | 0.0500 |
| 19 | 0.03 | — | — | — | — | — | — | — |
| 20 | 0.03 | — | — | — | — | — | — | — |
| 21 | 0.03 | — | — | — | — | — | — | — |
| 22 | 0.03 | — | — | — | — | — | — | — |

TABLE 2B

| | Cr | Mo | Co | B | Cu | Ni | V | Nb |
|---|---|---|---|---|---|---|---|---|
| 23 | 0.03 | — | — | — | — | — | — | — |
| 24 | 0.03 | — | — | — | — | — | — | — |
| 25 | 0.03 | — | — | — | — | — | — | — |
| 26 | 0.03 | — | — | — | — | — | — | — |
| 27 | 0.03 | — | — | — | — | — | — | — |
| 28 | 0.03 | — | — | — | — | — | — | — |

| | |
|---|---|
| 29 | The same as in Example 1 |
| 30 | The same as in Example 1 |
| 31 | The same as in Example 1 |
| 32 | The same as in Example 1 |
| 33 | The same as in Example 1 |
| 34 | The same as in Example 1 |
| 35 | The same as in Example 1 |
| 36 | The same as in Example 1 |
| 37 | The same as in Example 1 |
| 38 | The same as in Example 1 |
| 39 | The same as in Example 1 |
| 40 | The same as in Example 1 |
| 41 | The same as in Example 1 |
| 42 | The same as in Example 1 |
| 43 | The same as in Example 1 |
| 44 | The same as in Example 1 |

TABLE 3A

| | | | | | | | | γ- |
|---|---|---|---|---|---|---|---|---|
| | | | | | | | | temper- |
| | | | | | | | | ature |
| | | | | | | | | upper |
| | Ti | Mg | Ca | REM | N | Zr | Al | limit |
| 1 | 0.0010 | — | — | — | 0.0040 | — | 0.0010 | 1380 |
| 2 | 0.0010 | — | — | — | 0.0040 | — | 0.0009 | 1380 |
| 3 | 0.0010 | — | — | — | 0.0040 | — | 0.0009 | 1425 |
| 4 | 0.0008 | — | — | — | 0.0035 | — | 0.0008 | 1420 |
| 5 | 0.0008 | — | — | — | 0.0035 | — | 0.0008 | 1420 |
| 6 | 0.0009 | — | — | — | 0.0045 | — | 0.0006 | 1400 |
| 7 | 0.0009 | — | — | — | 0.0045 | — | 0.0006 | 1400 |
| 8 | 0.0007 | — | — | — | 0.0048 | — | 0.0010 | 1395 |
| 9 | 0.0007 | — | — | — | 0.0048 | — | 0.0010 | 1395 |
| 10 | 0.0006 | — | — | — | 0.0039 | — | 0.0007 | 1390 |
| 11 | 0.0006 | — | — | — | 0.0039 | — | 0.0007 | 1390 |
| 12 | 0.0010 | — | — | — | 0.0040 | — | 0.0010 | 1385 |
| 13 | 0.0010 | — | — | — | 0.0040 | — | 0.0010 | 1385 |
| 14 | 0.0010 | — | — | — | 0.0040 | — | 0.0010 | 1385 |
| 15 | 0.0010 | — | — | — | 0.0040 | — | 0.0010 | 1385 |
| 16 | 0.0010 | — | — | — | 0.0040 | — | 0.0010 | 1385 |
| 17 | 0.0010 | — | — | — | 0.0040 | — | 0.0010 | 1385 |
| 18 | 0.0010 | — | — | — | 0.0040 | — | 0.0010 | 1385 |
| 19 | 0.0500 | — | — | — | 0.0040 | — | 0.0010 | 1385 |
| 20 | 0.0060 | — | — | — | 0.0040 | — | 0.0010 | 1385 |
| 21 | 0.0010 | 0.0200 | — | — | 0.0040 | — | 0.0010 | 1385 |
| 22 | 0.0010 | — | 0.0200 | — | 0.0040 | — | 0.0010 | 1385 |

TABLE 3B

| | | | | | | | | γ- |
|---|---|---|---|---|---|---|---|---|
| | | | | | | | | temper- |
| | | | | | | | | ature |
| | | | | | | | | upper |
| | Ti | Mg | Ca | REM | N | Zr | Al | limit |
| 23 | 0.0010 | — | — | 0.0500 | 0.0040 | — | 0.0010 | 1385 |
| 24 | 0.0010 | — | — | — | 0.0200 | — | 0.0010 | 1385 |
| 25 | 0.0010 | — | — | — | 0.0060 | — | 0.0010 | 1385 |
| 26 | 0.0010 | — | — | — | 0.0040 | 0.0200 | 0.0010 | 1385 |
| 27 | 0.0010 | — | — | — | 0.0040 | — | 1.0000 | 1385 |
| 28 | 0.0010 | — | — | — | 0.0040 | — | 0.0200 | 1385 |

| | |
|---|---|
| 29 | The same as in Example 1 |
| 30 | The same as in Example 1 |
| 31 | The same as in Example 1 |
| 32 | The same as in Example 1 |
| 33 | The same as in Example 1 |
| 34 | The same as in Example 1 |
| 35 | The same as in Example 1 |
| 36 | The same as in Example 1 |
| 37 | The same as in Example 1 |
| 38 | The same as in Example 1 |
| 39 | The same as in Example 1 |
| 40 | The same as in Example 1 |
| 41 | The same as in Example 1 |
| 42 | The same as in Example 1 |
| 43 | The same as in Example 1 |
| 44 | The same as in Example 1 |

TABLE 4A

| | | | | | Number of | Breakage |
|---|---|---|---|---|---|---|
| | TA | TC | TA + TC | TA − TC | MS | resistance |
| 1 | 750 | 680 | 1430 | 70 | A | A |
| 2 | 720 | 660 | 1380 | 60 | A | A |
| 3 | 720 | 660 | 1380 | 60 | A | A |
| 4 | 750 | 650 | 1400 | 100 | A | A |
| 5 | 750 | 650 | 1400 | 100 | A | A |
| 6 | 740 | 630 | 1370 | 110 | A | A |
| 7 | 740 | 630 | 1370 | 110 | A | A |
| 8 | 800 | 700 | 1500 | 100 | A | A |
| 9 | 800 | 700 | 1500 | 100 | A | A |
| 10 | 700 | 680 | 1380 | 20 | A | A |
| 11 | 700 | 680 | 1380 | 20 | A | A |
| 12 | 700 | 680 | 1380 | 20 | A | A |
| 13 | 690 | 670 | 1360 | 20 | A | A |
| 14 | 800 | 680 | 1480 | 120 | A | A |
| 15 | 700 | 660 | 1360 | 40 | A | A |
| 16 | 700 | 660 | 1360 | 40 | A | A |
| 17 | 760 | 640 | 1400 | 120 | A | A |
| 18 | 760 | 640 | 1400 | 120 | A | A |
| 19 | 760 | 640 | 1400 | 120 | A | A |
| 20 | 760 | 640 | 1400 | 120 | A | A |
| 21 | 740 | 660 | 1400 | 80 | A | A |
| 22 | 740 | 660 | 1400 | 80 | A | A |

TABLE 4B

| | | | | | Number of | Breakage |
|---|---|---|---|---|---|---|
| | TA | TC | TA + TC | TA − TC | MS | resistance |
| 23 | 740 | 660 | 1400 | 80 | A | A |
| 24 | 740 | 670 | 1410 | 70 | A | A |
| 25 | 740 | 670 | 1410 | 70 | A | A |
| 26 | 780 | 680 | 1460 | 100 | A | A |
| 27 | 780 | 700 | 1480 | 80 | A | A |
| 28 | 780 | 700 | 1480 | 80 | A | A |
| 29 | 850 | 720 | 1570 | 130 | A | A |
| 30 | 650 | 600 | 1250 | 50 | B | B |
| 31 | 640 | 580 | 1220 | 60 | C | C |
| 32 | 600 | 580 | 1180 | 20 | C | C |
| 33 | 800 | 750 | 1550 | 50 | A | A |
| 34 | 750 | 560 | 1310 | 190 | B | B |
| 35 | 650 | 640 | 1290 | 10 | B | B |
| 36 | 700 | 560 | 1260 | 140 | B | B |
| 37 | 660 | 550 | 1210 | 110 | C | C |
| 38 | 600 | 500 | 1100 | 100 | C | C |
| 39 | 700 | 640 | 1340 | 60 | A | A |
| 40 | 700 | 620 | 1320 | 80 | B | B |
| 41 | 650 | 560 | 1210 | 90 | B | B |
| 42 | 740 | 600 | 1340 | 140 | A | A |
| 43 | 760 | 600 | 1360 | 160 | B | B |
| 44 | 800 | 600 | 1400 | 200 | B | B |

The welded rails obtained by the manufacturing method of Examples 31 and 32 were insufficient in breakage resistance. In the welded rails, the number of martensite was excessively large. This is presumably because the cooling stop temperature (TA) of the outline surface of the head jaw in the welding center of the weld joint portion was excessively low.

The welded rail obtained by the manufacturing method of Example 37 was insufficient in breakage resistance. In the welded rails, the number of martensite was excessively large. This is presumably because the cooling stop temperature (TC) of the outline surface of the head top corner in the welding center of the weld joint portion was excessively low.

The welded rail obtained by the manufacturing method of Example 38 was insufficient in breakage resistance. In the welded rail, the number of martensite was excessively large. This is presumably because both TA and TC were excessively low.

On the other hand, all of the welded rails obtained by the manufacturing method that was appropriate in all of the chemical composition of the rail, TA, and TC were exceptional in breakage resistance.

### REFERENCE SIGNS LIST

1 Flash butt welded rail (welded rail)
11 Rail portion
111 Rail head
1111 Outline surface of rail head top
1112 Outline surface of rail head jaw
1113 Outline surface of rail head side
1114 Outline surface of rail head top corner
112 Rail column
113 Rail bottom
12 Weld joint portion
121 Head (of weld joint portion)
1211 Outline surface of head top (of weld joint portion)
1212 Outline surface of jaw portion on head (of weld joint portion)
1213 Outline surface of head side (of weld joint portion)
1214 Outline surface of corner portion on head top (of weld joint portion)
122 Column (of weld joint portion)
123 Bottom (of weld joint portion)
12H Heat-affected zone (HAZ)
A Welding center
B Center in width direction
C Martensite structure evaluation region
2 Cooling device
21 Refrigerant injection means
22 Rail installation portion
23 Refrigerant supply means
24 Control means

1. A manufacturing method of a flash butt welded rail having a plurality of rail portions; and a weld joint portion joining the plurality of rail portions, the method comprising:
flash butt welding rails, the rails including, as a chemical composition, in terms of unit mass %, C: 0.70 to 1.20%, Si: 0.05 to 2.00%, Mn: 0.05 to 2.00%, P≤0.0300%, S≤0.0300%, Cr: 0 to 2.00%, Mo: 0 to 0.50%, Co: 0 to 1.00%, B: 0 to 0.0050%, Cu: 0 to 1.00%, Ni: 0 to 1.00%, V: 0 to 0.200%, Nb: 0 to 0.0500%, Ti: 0 to 0.0500%, Mg: 0 to 0.0200%, Ca: 0 to 0.0200%, REM: 0 to 0.0500%, N: 0 to 0.0200%, Zr: 0 to 0.0200%, Al: 0 to 1.0000%, and a balance including Fe and impurities; and
forced cooling the weld joint portion immediately after the flash butt welding is completed, wherein
when the forced cooling is performed from an austenite temperature range, in a welding center of the weld joint portion, a cooling stop temperature TC of an outline surface of a head top corner is 560° C. or higher and 850° C. or lower; and
a cooling stop temperature TA of an outline surface of a head jaw is 650° C. or higher and 950° C. or lower.

2. The manufacturing method of a flash butt welded rail according to claim 1, wherein
the cooling stop temperature TC of the outline surface of the head top corner and the cooling stop temperature TA of the outline surface of the head jaw satisfy formulae 1 and 2 below:
$$TA + TC \geq 1340 \qquad formula 1$$
$$0 \leq TA - TC \leq 140. \qquad formula 2$$

3. The manufacturing method of a flash butt welded rail according to claim 1, wherein
the rails include, as the chemical composition, in terms of unit mass %, one or more groups of:
Group a: Cr: 0.05% or more and 2.00% or less, and Mo: 0.01% or more and 0.50% or less;
Group b: Co: 0.01% or more and 1.00% or less;
Group c: B: 0.0001% or more and 0.0050% or less;
Group d: one or two of Cu: 0.01% or more and 1.00% or less and Ni: 0.01% or more and 1.00% or less;
Group e: one or more of V: 0.005% or more and 0.200% or less, Nb: 0.0010% or more and 0.0500% or less, and Ti: 0.0010% or more and 0.0500% or less;
Group f: one or more of Mg: 0.0005% or more and 0.0200% or less, Ca:
0.0005% or more and 0.0200% or less, and REM: 0.0005% or more and 0.0500% or less;
Group g: N: 0.0025% or more and 0.0200% or less;
Group h: Zr: 0.0001% or more and 0.0200% or less; and
Group i: Al: 0.0010% or more and 1.0000% or less.

4. The manufacturing method of a flash butt welded rail according to claim 1, wherein the forced cooling is air cooling.

5. The manufacturing method of a flash butt welded rail according to claim 2, wherein
the rails include, as the chemical composition, in terms of unit mass %, one or more groups of:
Group a: Cr: 0.05% or more and 2.00% or less, and Mo: 0.01% or more and 0.50% or less;
Group b: Co: 0.01% or more and 1.00% or less;
Group c: B: 0.0001% or more and 0.0050% or less;
Group d: one or two of Cu: 0.01% or more and 1.00% or less and Ni: 0.01% or more and 1.00% or less;
Group e: one or more of V: 0.005% or more and 0.200% or less, Nb: 0.0010% or more and 0.0500% or less, and Ti: 0.0010% or more and 0.0500% or less;
Group f: one or more of Mg: 0.0005% or more and 0.0200% or less, Ca:
0.0005% or more and 0.0200% or less, and REM: 0.0005% or more and 0.0500% or less;
Group g: N: 0.0025% or more and 0.0200% or less;
Group h: Zr: 0.0001% or more and 0.0200% or less; and
Group i: Al: 0.0010% or more and 1.0000% or less.

6. The manufacturing method of a flash butt welded rail according to claim 2, wherein the forced cooling is air cooling.
